(19) United States
(12) Patent Application Publication
(10) Pub. No.: US 2008/0238772 A1
(43) Pub. Date: Oct. 2, 2008

(54) METHOD AND APPARATUS FOR USING MULTIPATH SIGNAL IN GPS ARCHITECTURE

(75) Inventors: ANDREY A. SOLOVIEV, THE PLAINS, OH (US); FRANK VAN GRAAS, LANCASTER, OH (US)

Correspondence Address: CALFEE HALTER & GRISWOLD, LLP, 800 SUPERIOR AVENUE, SUITE 1400, CLEVELAND, OH, 44114, US

(73) Assignee: OHIO UNIVERSITY, ATHENS, OH (US)

(21) Appl. No.: 12/019,165

(22) Filed: Jan. 24, 2008

Related U.S. Application Data
(60) Provisional application No. 60/886,425, filed on Jan. 24, 2007.

(51) Int. Cl. G01S 5/14

(52) U.S. Cl. 342/357.14

(57) ABSTRACT

A method and apparatus for constructive use of a multipath signal in GPS signal processing is provided. In one embodiment, the method includes: a) receiving a GPS signal at a mobile object from a satellite vehicle, b) determining a distance characteristic relating a reflecting object to the mobile object, c) determining at least one inertial characteristic associated with the mobile object, d) predicting at least one multipath signal characteristic associated with reflection of the GPS signal by the reflecting object toward the mobile object, and e) determining the GPS signal received in a) includes a multipath signal associated with reflection of the GPS signal by the reflecting object toward the mobile object. In one embodiment, the apparatus includes: a GPS receiver, a storage device, an inertial measurement device, and a controller. In another embodiment, the apparatus also includes a distance measurement device.

### CROSS-REFERENCE TO RELATED APPLICATIONS

This application claims priority to, and any other benefit of, U.S. Ser. No. 60/886,425, filed Jan. 24, 2007 (Attorney Docket Number 27211.04257), the contents of which are fully incorporated herein by reference.

### BACKGROUND

Outdoor localization services based on Global Navigation Satellite Systems (GNSSs) and Global Positioning System (GPS) receivers have tremendously matured over the past decade and are widely available in a variety of applications. Current GNSS user performance, however, is fragmented by environmental boundaries. GPS receiver performance is generally sufficient for most localization applications in rural and suburban environments. In contrast, urban environments with a high density of tall buildings, generally referred to as urban canyons, pose a very challenging environment for most GPS receivers. It is very common for GPS receivers to be rendered useless in urban environments, as one satellite after another is blocked by buildings and other urban structures. Based at least on the foregoing, the performance of GPS receivers in certain urban environments is at least sub-optimal.

### SUMMARY

In one aspect, a method that addresses the need stated above is provided. In one embodiment, the method includes: a) receiving a first GPS signal at a mobile object from a first satellite vehicle, b) determining a distance characteristic relating a first reflecting object to the mobile object, c) determining at least one inertial characteristic associated with the mobile object, d) predicting at least one multipath signal characteristic associated with reflection of the first GPS signal by the first reflecting object toward the mobile object, and e) determining the first GPS signal received in a) includes a first multipath signal associated with reflection of the first GPS signal by the first reflecting object toward the mobile object.

In one aspect, an apparatus that addresses the need stated above is provided. In one embodiment, the apparatus includes: a GPS receiver adapted to receive a first GPS signal from a first satellite vehicle, a storage device adapted to store a first parameter associated with a distance between a first reflecting object and the apparatus, an inertial measurement device adapted to measure at least one parameter associated with movement of the apparatus, and a controller in communication with the GPS receiver, storage device, and inertial measurement device, the controller being adapted to i) determine a first distance characteristic relating the first reflecting object to the apparatus, ii) determine at least one inertial characteristic associated with the apparatus, iii) predict at least one multipath signal characteristic associated with reflection of the first GPS signal by the first reflecting object toward the apparatus, iv) determine the first GPS signal received by the GPS receiver includes a first multipath signal associated with reflection of the first GPS signal by the first reflecting object toward the apparatus, v) track the first satellite vehicle based at least in part on a first carrier frequency component of the first multipath signal, and vi) use at least one of carrier frequency, carrier phase, and GPS data from the first satellite vehicle based at least in part on at least one of a first GPS carrier component and a first GPS data component of the first multipath signal.

### DRAWINGS

These and other features, aspects, and advantages of the present invention will become better understood with regard to the accompanying drawings, following description, and appended claims.

FIG. 1 is a block diagram of an exemplary embodiment of an operating environment for an exemplary embodiment of a mobile object with an exemplary embodiment of a GPS receiver.

FIG. 2 is a block diagram of another exemplary embodiment of an operating environment for another exemplary embodiment of a mobile object with the GPS receiver of FIG. 1.

FIG. 3 is a flow chart of an exemplary process for identifying an exemplary multipath signal associated with an exemplary GPS signal.

FIG. 4, in conjunction with FIG. 3, is a flow chart of an exemplary process for constructively using an exemplary multipath signal associated with an exemplary GPS signal.

FIG. 5, in conjunction with FIG. 3, is a flow chart of an exemplary process for constructively using several exemplary multipath signals associated with several corresponding exemplary GPS signals.

FIG. 6, in conjunction with FIG. 3, is a flow chart of another exemplary process for constructively using several exemplary multipath signals associated with several corresponding exemplary GPS signals.

FIG. 7 is a flow chart of an exemplary process for using signals from a plurality of radio navigation satellites while a receiver is mobile.

FIG. 8 is a block diagram of an exemplary embodiment of a receiver for using low carrier-to-noise ratio (CNR) signals from a plurality of radio navigation satellites while the receiver is mobile.

FIG. 9 is a three-dimensional (3D) image of an exemplary GPS signal showing the signal as directly received and also received as a multipath signal.

FIG. 10 is a diagram of an exemplary embodiment of an apparatus and associated process for predicting velocity vectors for a satellite vehicle and a moving object receiving a reflected GPS signal from the satellite vehicle.

FIG. 11 is a diagram of an exemplary embodiment of an apparatus and associated process for matching predicted and measured direct and multipath GPS signals and use of the measured signals for navigation of the apparatus.

FIG. 12 is a diagram of an exemplary embodiment of an apparatus and associated process for measuring frequencies in received low CNR GPS signals.

FIG. 13 is a diagram of an exemplary embodiment of an apparatus and associated process for using measured direct and multipath GPS signals for navigation of the apparatus.

FIG. 14 is a diagram of an exemplary embodiment of an apparatus and associated process for predicting Doppler frequency shifts for reflected GPS signals.

FIG. 15 is a diagram of another exemplary embodiment of an apparatus and associated process for predicting Doppler frequency shifts for reflected GPS signals.

FIG. 16A shows a view of an equipment rack in a vehicle configured with an exemplary embodiment of an apparatus that enables use of a multipath GPS signal.

FIG. 16B shows a view of roof-mounted equipment for the vehicle of FIG. 16A.

FIG. 17 is a block diagram of an exemplary embodiment of an apparatus that enables use of a multipath GPS signal.

FIG. 18 is a diagram of an exemplary embodiment of an apparatus and associated process for comparing a measured multipath signal to a predicted multipath signal.

FIG. 19 is a diagram of another exemplary embodiment of an apparatus and associated process for comparing a measured multipath signal to a predicted multipath signal and using a matched multipath signal for navigation processing.

### DESCRIPTION

The following paragraphs include definitions of exemplary terms used within this disclosure. Except where noted otherwise, variants of all terms, including singular forms, plural forms, and other affixed forms, fall within each exemplary term meaning. Except where noted otherwise, capitalized and non-capitalized forms of all terms fall within each meaning.

“Circuit,” as used herein includes, but is not limited to, hardware, firmware, software or combinations of each to perform a function(s) or an action(s). For example, based on a desired feature or need, a circuit may include a software controlled microprocessor, discrete logic such as an application specific integrated circuit (ASIC), or another programmed logic device. A circuit may also be fully embodied as software. As used herein, “circuit” is considered synonymous with “logic.”

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Computer communication,” as used herein includes, but is not limited to, a communication between two or more computer components and can be, for example, a network transfer, a file transfer, an applet transfer, an e-mail, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer component,” as used herein includes, but is not limited to, a computer-related entity, either hardware, firmware, software, a combination thereof, or software in execution. For example, a computer component can be, but is not limited to being, a processor, an object, an executable, a process running on a processor, a thread of execution, a program and a computer. By way of illustration, both an application running on a server and the server can be computer components. One or more computer components can reside within a process or thread of execution and a computer component can be localized on one computer or distributed between two or more computers.

“Controller,” as used herein includes, but is not limited to, any circuit or device that coordinates and controls the operation of one or more input or output devices. For example, a controller can include a device having one or more processors, microprocessors, or central processing units (CPUs) capable of being programmed to perform input or output functions.

“Data store,” as used herein, include, but is not limited to, a physical or logical entity that can store data. A data store may be, for example, a database, a table, a file, a list, a queue, a heap, and so on. A data store may reside in one logical or physical entity or may be distributed between two or more logical or physical entities.

“Logic,” as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software. As used herein, “logic” is considered synonymous with “circuit.”

“Measurement,” as used herein includes, but is not limited to, an extent, magnitude, size, capacity, amount, dimension, characteristic or quantity ascertained by measuring. Example measurements may be provided, but such examples are not intended to limit the scope of measurements that the systems and methods described herein can employ.

“Operable connection” (or a connection by which entities are “operably connected”), as used herein includes, but is not limited to, a connection in which signals, physical communication flow, or logical communication flow may be sent or received. Usually, an operable connection includes a physical interface, an electrical interface, or a data interface, but an operable connection may include differing combinations of these or other types of connections sufficient to allow operable control.

“Operative communication,” as used herein includes, but is not limited to, a communicative relationship between devices, logic, or circuits, including mechanical and pneumatic relationships. Direct and indirect electrical, electromagnetic, and optical connections are examples of connections that facilitate operative communications. Linkages, gears, chains, belts, push rods, cams, keys, attaching hardware, and other components contributing to mechanical relations between items are examples of components facilitating operative communications. Pneumatic devices and interconnecting pneumatic tubing may also contribute to operative communications. Two devices are in operative communication if an action from one causes an effect in the other, regardless of whether the action is modified by some other device. For example, two devices in operative communication may be separated by one or more of the following: i) amplifiers, ii) filters, iii) transformers, iv) optical isolators, v) digital or analog buffers, vi) analog integrators, vii) other electronic circuitry, viii) fiber optic transceivers, ix) Bluetooth communications links, x) 802.11 communications links, xi) satellite communication links, and xii) other wireless communication links. As another example, an electromagnetic sensor is in operative communication with a signal if it receives electromagnetic radiation from the signal. As a final example, two devices not directly connected to each other, but both capable of interfacing with a third device, e.g., a central processing unit (CPU), are in operative communication.

“Or,” as used herein, except where noted otherwise, is inclusive, rather than exclusive. In other words, “or’ is used to describe a list of alternative things in which one may choose one option or any combination of alternative options. For example, “A or B” means “A or B or both” and “A, B, or C” means “A, B, or C, in any combination.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

“Processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

“Query,” as used herein includes, but is not limited to, a semantic construction that facilitates gathering and processing information. A query might be formulated in a database query language like Standard Query Language (SQL) or Object Query Language (OQL). A query might be implemented in computer code (e.g., C+, C++, JavaScript) that can be employed to gather information from various data stores or information sources.

“Signal,” as used herein includes, but is not limited to, one or more electrical signals, including analog or digital signals, one or more computer instructions, a bit or bit stream, or the like.

“Software,” as used herein includes, but is not limited to, one or more computer readable or executable instructions that cause a computer or another electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system, or other types of executable instructions. It will be appreciated by one of ordinary skill in the art that the form of software is dependent on, for example, requirements of a desired application, the environment it runs on, or the desires of a designer/programmer or the like.

“Software component,” as used herein includes, but is not limited to, a collection of one or more computer readable or executable instructions that cause a computer or other electronic device to perform functions, actions or behave in a desired manner. The instructions may be embodied in various forms like routines, algorithms, modules, methods, threads, or programs. Software components may be implemented in a variety of executable or loadable forms including, but not limited to, a stand-alone program, a servelet, an applet, instructions stored in a memory, and the like. Software components can be embodied in a single computer component or can be distributed between computer components.

The following table includes long form definitions of exemplary acronyms, abbreviations, and labels for variables and constants in mathematical expressions used within this disclosure. Except where noted otherwise, variants of all items, including singular forms, plural forms, and other affixed forms, fall within each exemplary meaning. Except where noted otherwise, capitalized and non-capitalized forms of all items fall within each meaning.

Acronym Long Form
2D Two-dimensional
3D Three-dimensional
ASIC Application specific integrated circuit
BLOB Binary large object
cm Centimeter
CNR Carrier-to-noise ratio
COTS Commercial-off-the-shelf
CP Carrier phase
CPU Central processing unit
dB Decibel
DQI Digital quartz IMU
DR Dead reckoning
DSP Digital signal processor
ENU East-North-Up
EPROM Erasable programmable read-only memory
FAA Federal Aviation Administration
FPGA Field programmable gate array
f_{L1} Frequency of GPS Link 1 (L₁) carrier
fₘₐₓ Frequency of the local energy maximum
GNSS Global navigation satellite system
GPS Global positioning system
HTTP Hypertext transfer protocol
Hz Hertz
IMU Inertial measurement unit
INS Inertial navigation system
iono Ionosphere
LAAS Local area augmentation system
LADAR Laser radar
LAN Local area network
LMS Laser measurement sensor or Least mean squares
LOS Line of sight
LS Laser scanner
m Meter
mm Millimeter
nₚₗₐₙₑ Plane normal vector
OQL Object query language
PC Personal computer
PRN Pseudorandom number
PROM Programmable read-only memory
RAM Random access memory
rcvr Receiver
RF Radio frequency
ROM Read-only memory
R_{rcvr} Receiver position vector (x_{rcvr}, y_{rcvr}, z_{rcvr} are vector components)
Rₛᵥ SV position vector (xₛᵥ, yₛᵥ, zₛᵥ are vector components)
s Second
SDR Software-defined radio
SQL Standard query language
std Standard deviation
SV Satellite vehicle
tropo Troposphere
WAN Wide area network

Deep integration between a GPS receiver and an inertial navigation system (INS) allows for processing of GPS signals at a very low signal-to-noise ratio (e.g., carrier-to-noise ratio (CNR) as low as 12 dB-Hz). For additional details on processing GPS signal at very low CNR see U.S. Pat. App. Pub. No. 2006/0071851 to van Graas et al., the contents of which are fully incorporated herein by reference. As a result, GPS signals can be potentially used for navigation even in dense urban environments where signal propagation between satellites and the end user is often attenuated by buildings and structures. Urban applications are generally characterized by multipath signal environments. On one hand, it is critical to distinguish between a direct signal and a corresponding multipath signal for the efficient localization using the corresponding carrier frequency, carrier phase, or GPS data in any combination. On the other hand, multipath signal reflections can be used as an additional source of navigation information especially for those cases where the number of direct signal path (i.e., LOS) satellites is limited. Several embodiments of methods and apparatus utilizing multipath reflections in a deeply integrated GPS/INS architecture or integrated GNSS/Dead reckoning (DR) architecture for navigation in urban environments are described herein. In one embodiment, characteristics of surrounding surfaces (e.g., extracted from laser scanner data or from building models that are pre-saved in a digital map) and inertial data are used to predict multipath signal reflection frequencies. The predicted multipath signal frequencies may be matched to local energy maxima of a three dimensional (3D) satellite signal image to identify direct signal and multipath signal reflections. Finally, direct signal and multipath signal reflections identified are used for navigation.

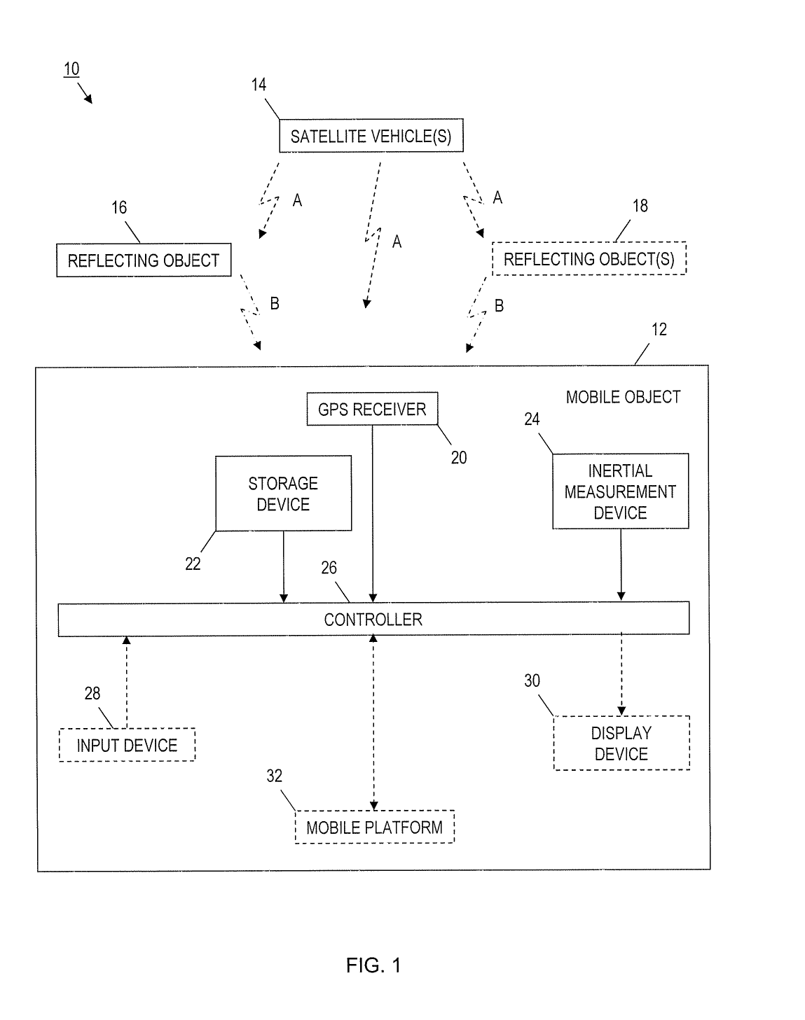

With reference to FIG. 1, an exemplary embodiment of an operating environment 10 includes an exemplary embodiment of a mobile object 12, a plurality of satellite vehicles (SVs) 14, and a reflecting object 16. The SVs 14 orbit the Earth and transmit GPS signals in conjunction with a GNSS. Each GPS signal includes a carrier component and a data component. The GPS carrier component includes a carrier frequency and a carrier phase. The GPS data component includes a pseudorandom ranging code and a navigation message. In other embodiments, the operating environment 10 may also include one or more additional reflecting objects 18. The mobile object 12 may include a GPS receiver 20, a storage device 22, an inertial measurement device 24, and a controller 26. In other embodiments, the mobile object 12 may also include an input device 28, a display device 30, or a mobile platform 32, in any combination.

In the operating environment 10, the GPS receiver 20 may be in operative communication with one or more SVs 14. Generally, the GPS receiver 20 receives a GPS signal from each SV 14 with which it is in communication. For example, in the embodiment being described, the GPS receiver 20 may be in operative communication with a first SV 14.

Each GPS signal received by the GPS receiver 20 may include a direct signal or one or more multipath signals, in any combination. A direct signal reaches the GPS receiver 20 via a line-of-sight (LOS) path from the corresponding SV 14. An example of a direct signal is shown by dashed line A. A multipath signal reaches the GPS receiver 20 via an alternate path due to reflection of the direct signal A, for example, by a reflecting object 16, 18. Examples of multipath signals are shown by dashed lines B. Notably, the multipath signals B may be received even when the GPS receiver 20 is not within LOS of the corresponding SV 14.

The storage device 22 may store a previously-generated digital map modeling an operational environment associated with the mobile object 12. In one embodiment, the digital map may represent a scaled version of the operational environment in three dimensions. The digital map may include models representing various reflecting objects 16, 18 within the operational environment. In one embodiment, a given model may represent a scaled version of a corresponding reflecting object 16, 18 in three dimensions. For example, in the embodiment being described, the digital map may include a first model representing a first reflecting object 16 associated with the operational environment.

The inertial measurement device 24 measures at least one parameter associated with movement of the mobile object 12 within the operating environment 10. The inertial measurement device 24 may measure parameters indicative of whether the mobile object 12 is stationary or moving. If moving, the inertial measurement device 24 may measure parameters indicative of the speed or direction of the mobile object 12.

In one embodiment, the inertial measurement device 24, may include an inertial measurement unit (IMU) that measures pitch, roll, and velocity parameters. In other embodiments, the inertial measurement device 24, may include other devices suitable for measuring any combination of speed or direction parameters.

The controller 26 is in operative communication with the GPS receiver 20, storage device 22, and the inertial measurement device 24. The controller 26, for example, may determine a distance characteristic relating the first reflecting object 16 to the mobile object 12. The determined distance characteristic may be based at least in part on the first model in the digital map of the operational environment stored in the storage device 22 and associated with the first reflecting object 16. The controller 26 may determine at least one inertial characteristic associated with the mobile object 12. The determined inertial characteristic(s) may be based at least in part on one or more measured parameters received from the inertial measurement device 24.

The controller 26 may predict at least one multipath signal B characteristic associated with reflection of a direct signal A from the first SV 14 by the first reflecting object 16 toward the mobile object 12. The predicted multipath signal B characteristic(s) may be based at least in part on the distance characteristic associated with the first reflecting object 16 or the inertial characteristic(s) associated with the mobile object 12. The controller 26 may determine that the first GPS signal received by the GPS receiver 20 includes a multipath signal B associated with reflection of the direct signal A from the first SV 14 by the first reflecting object 16 toward the mobile object 12. The multipath signal B determination may be based at least in part on the predicted multipath signal B characteristic(s) associated with the first reflecting object 16 and first SV 14. The controller 26 may track the first SV 14 based at least in part on a carrier frequency component of the multipath signal B associated with the first SV 14. The controller 26 may use carrier frequency, carrier phase, or GPS data from the first SV 14 in any combination based at least in part on at least one of a GPS carrier component and a GPS data component of the multipath signal B associated with the first SV 14. In one embodiment, the controller 26 may use the carrier frequency, carrier phase, or GPS data in any combination in conjunction with navigation of the mobile object 12 through at least one of a benign urban environment, a moderate urban environment, and a difficult urban environment. An urban environment may be classified as benign, for example, if GPS signals from a minimum of three SVs exist with CNRs consistently above 32 dB-Hz on all streets. An urban environment may be classified as moderate, for example, if GPS signals from a minimum of three SVs exist with CNRs consistently above 32 dB-Hz on major streets, but signals from fewer SVs may be available on small streets and in alleys. An urban environment may be classified as difficult, for example, if GPS signals from a minimum of three SVs exist with CNRs consistently above 32 dB-Hz only on major streets. These classifications may require the GPS signals from the same SVs to be consistently above the tracking threshold, not merely the instantaneous total of SVs with ID numbers that differ from one measurement to the next. For additional information on tracking the GPS signal and use of the carrier frequency, carrier phase, and GPS data see U.S. Pat. App. Pub. No. 2006/0071851 to van Graas et al., the contents of which are fully incorporated herein by reference.

The input device 28 is optional and may include a user input device for operation or control by a user. In another embodiment, the input device 28 may include any suitable type of communication interface for any suitable type of local or remote device associated with operation or control of the mobile object 12. Similarly, the display device 30 is optional and may include any suitable type of local or remote display device, such as a display monitor, an alphanumeric display, or illuminated indicator(s). The mobile platform 32 is optional and may include any suitable type of platform for transporting the mobile object 12 on land, sea, or air. For example, the mobile platform may include an automobile, truck, trailer, air vehicle, boat, or ship.

In another embodiment of the mobile object 12, the GPS receiver 20 may receive a second GPS signal from a second SV 14. In the embodiment being described, the controller 26 may predict at least one second multipath signal B characteristic associated with reflection of a direct signal A from the second SV 14 by the first reflecting object 16 toward the mobile object 12. The predicted second multipath signal B characteristic(s) may be based at least in part on the distance characteristic associated with the first reflecting object 16 or the inertial characteristic(s) associated with the mobile object 12. The controller 26 may determine that the second GPS signal received by the GPS receiver 20 includes a second multipath signal B associated with reflection of the direct signal A from the second SV 14 by the first reflecting object 16 toward the mobile object 12. The second multipath signal B determination may be based at least in part on the predicted second multipath signal B characteristic(s) associated with the first reflecting object 16 and the second SV 14. The controller 26 may track the second SV 14 based at least in part on a second carrier frequency component of the second multipath signal B. The controller 26 may use carrier frequency, carrier phase, or GPS data from the second SV 14 in any combination based at least in part on at least one of a second GPS carrier component and a second GPS data component of the second multipath signal B. The controller 26 may use the GPS data in conjunction with navigation of the mobile object 12 through at least one of a benign urban environment, a moderate urban environment, and a difficult urban environment.

In yet another embodiment of the mobile object 12, the GPS receiver 20 may be in operative communication with a second SV to receive a second GPS signal. In the embodiment being described, the digital map associated with the storage device 22 may include a second model representing a second reflecting object 18 associated with the operational environment. The controller 26, for example, may determine a second distance characteristic relating the second reflecting object 18 to the mobile object 12. The second distance characteristic may be based at least in part on the second model stored in the storage device 22 and associated with the second reflecting object 18. The controller 26 may predict at least one second multipath signal B characteristic associated with reflection of a direct signal A from the second SV 14 by the second reflecting object 18 toward the mobile object 12. The predicted second multipath signal B characteristic(s) may be based at least in part on the second distance characteristic associated with the second reflecting object 18 or the inertial characteristic(s) associated with the mobile object 12. The controller 26 may determine the second GPS signal received by the GPS receiver 20 includes a second multipath signal B associated with reflection of the direct signal A from the second SV 14 by the second reflecting object 18 toward the mobile object 12. The second multipath signal B determination may be based at least in part on the predicted second multipath signal B characteristic(s) associated with the second reflecting object 18 and the second SV 14. The controller 26 may track the second SV 14 based at least in part on a second carrier frequency component of the second multipath signal B. The controller 26 may use carrier frequency, carrier phase, or GPS data from the second SV 14 in any combination based at least in part on at least one of a second GPS carrier component and a second GPS data component of the second multipath signal B. The controller 26 may use the carrier frequency, carrier phase, or GPS data in any combination in conjunction with navigation of the mobile object 12 through at least one of a benign urban environment, a moderate urban environment, and a difficult urban environment.

The various aspects of FIG. 1 described above may be automated, semi-automated, or manual and may be implemented through hardware, software, firmware, or combinations thereof.

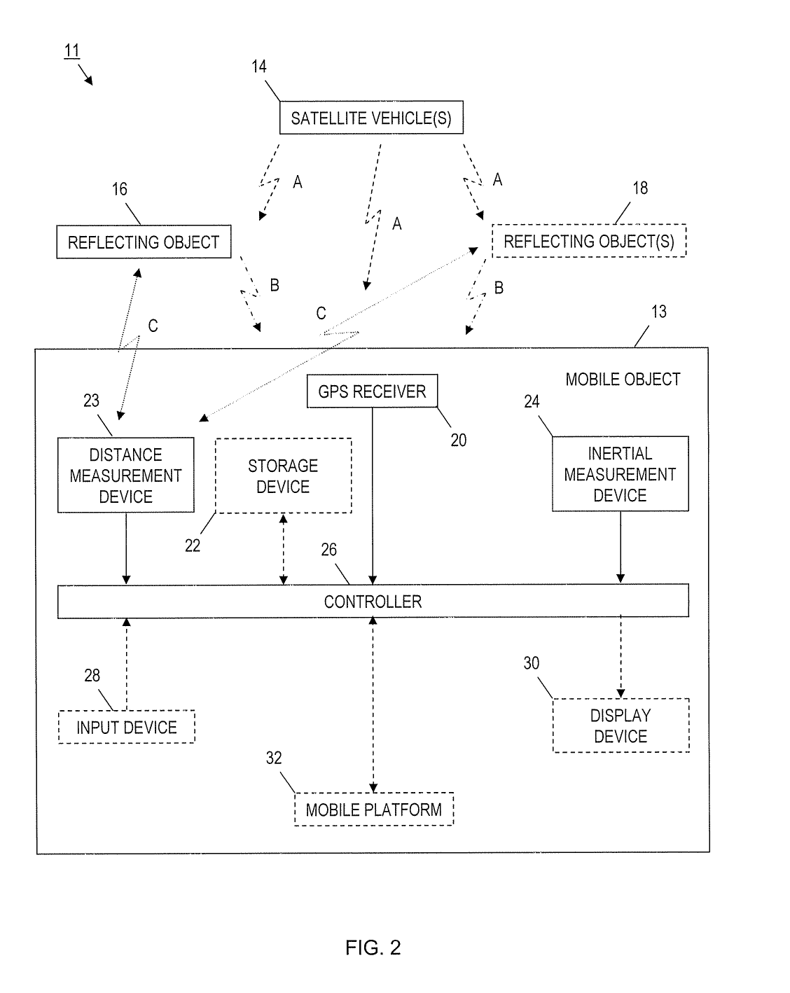

With reference to FIG. 2, an exemplary embodiment of an operating environment 11 includes an exemplary embodiment of a mobile object 13, a plurality of satellite vehicles (SVs) 14, and a reflecting object 16. In other embodiments, the operating environment 11 may also include one or more additional reflecting objects 18. The mobile object 13 may include a GPS receiver 20, a distance measurement device 23, an inertial measurement device 24, and a controller 26. In other embodiments, the mobile object 13 may also include the storage device 22, an input device 28, a display device 30, or a mobile platform 32, in any combination. The plurality of satellite vehicles (SVs) 14, reflecting objects 16, 18, GPS receiver 20, storage device 22, inertial measurement device 24, controller 26, input device 28, display device 30, and mobile platform 32 include the same features and operate in the same manner as described above in conjunction with the operating environment 10 and mobile object 12 of FIG. 1. The operating environment 11 and mobile object 13 operate similar to the operating environment 10 and mobile object 12 of FIG. 1. Generally, the operating environment 11 and mobile object 13 of FIG. 2 is different because it includes a distance measurement device 23 and the storage device 22 is optional.

The distance measurement device 23 may be within operative range of one or more reflecting objects 16, 18. The distance measurement device 23 may measure at least one parameter associated with a distance between a given reflecting object 16, 18 within its operative range and the mobile object 13. For example, in the embodiment being described, the distance measurement device 23 may be in operative range of a first reflecting object 16. In one embodiment, the distance measurement device 23 may perform one or more scans of the operational environment 11 to detect reflecting objects 16, 18 within range. If a single scan is implemented, the scan may be horizontal, pitched at a desired angle, incrementally pitched to follow a diagonal, or adjusted in any manner to suitably detect the reflecting objects 16, 18. For single scans, the processor may presume that surfaces of detected reflecting objects 16, 18 are vertically planar. If multiple scans are implemented, the resolution of detected reflecting objects 16, 18 is 3D and non-planar surfaces may be detected. Each scan of a multiple scan implementation may be horizontal, pitched at a desired angle, incrementally pitched to follow a diagonal, or adjusted in any manner to suitably detect desired points on reflecting objects 16, 18.

Examples of signals transmitted and detected by the distance measurement device 23 are shown by dashed lines C. In one embodiment, the distance measurement device 23 may include a laser scanner. Laser Measurement System, Model No. LMS 200, by SICK AG of Waldkirch, Germany is an example of a laser scanner that may be implemented. The LMS 200 operates by measuring the time of flight of laser light pulses. The “time of flight” method emits a pulsed laser beam. If the emitted beam meets an object, it is reflected. The reflection is registered by the scanner's receiver and the time between transmission and reception is used to determine the distance between the scanner and the reflecting object.

In other embodiments, the distance measurement device 23 may include other devices suitable for measuring or determining distance, such as an infrared (IR) device, a radio frequency (RF) transceiver, or a camera. In various embodiments, multiple distance measurement devices may be used in combination and different types of distance measurement devices may be used in combination to provide suitable measurements for determining distances between reflecting objects and the mobile object. Notably, dashed lines C are shown as bi-directional signals indicating that the corresponding reflecting object 16, 18 is passive with respect to the signal. In other embodiments, some types of reflecting objects 16, 18 may interact with the distance measurement device 23.

The controller 26 is in operative communication with the GPS receiver 20, distance measurement device 23, and the inertial measurement device 24. The controller 26, for example, may determine a distance characteristic relating the first reflecting object 16 to the mobile object 13. The determined distance characteristic may be based at least in part on one or more measured parameters received from the distance measurement device 23 and associated with the first reflecting object 16.

In another embodiment of the mobile object 13, the distance measurement device 23 may be within operative range of a second reflecting object 18 to measure at least one parameter associated with a distance between the second reflecting object 18 and the mobile object 13. In the embodiment being described, the controller 26 may determine a second distance characteristic relating the second reflecting object 18 to the mobile object 13. The second determined distance characteristic may be based at least in part on one or more measured parameters received from the distance measurement device 23 and associated with the second reflecting object 18.

In still another embodiment, the controller 26 may process measured parameters from the distance measurement device 23 to create a model corresponding to a given reflected object 16, 18. The controller 26 may store the model on the storage device 22 in a digital map representing the operating environment 11. In yet another embodiment, the controller 26 may process measured parameters from the distance measurement device 23 to create a digital map representing the operating environment 11. The controller 26 may store the digital map on the storage device 22. The digital map may include one or more models representing corresponding reflected objects 16, 18.

In yet another embodiment, the controller 26 may process measured parameters from the distance measurement device 23 to locate a current position of the mobile object 13 within a previously-generated digital map stored by the storage device 22. The previously-generated digital map modeling the operating environment 11 and including one or more models associated with corresponding reflecting objects 16, 18. The controller 26 may use its current position within the digital map to determine the distance characteristics relating one or more reflecting objects 16, 18 to the mobile object 13.

The various aspects of FIG. 2 described above may be automated, semi-automated, or manual and may be implemented through hardware, software, firmware, or combinations thereof.

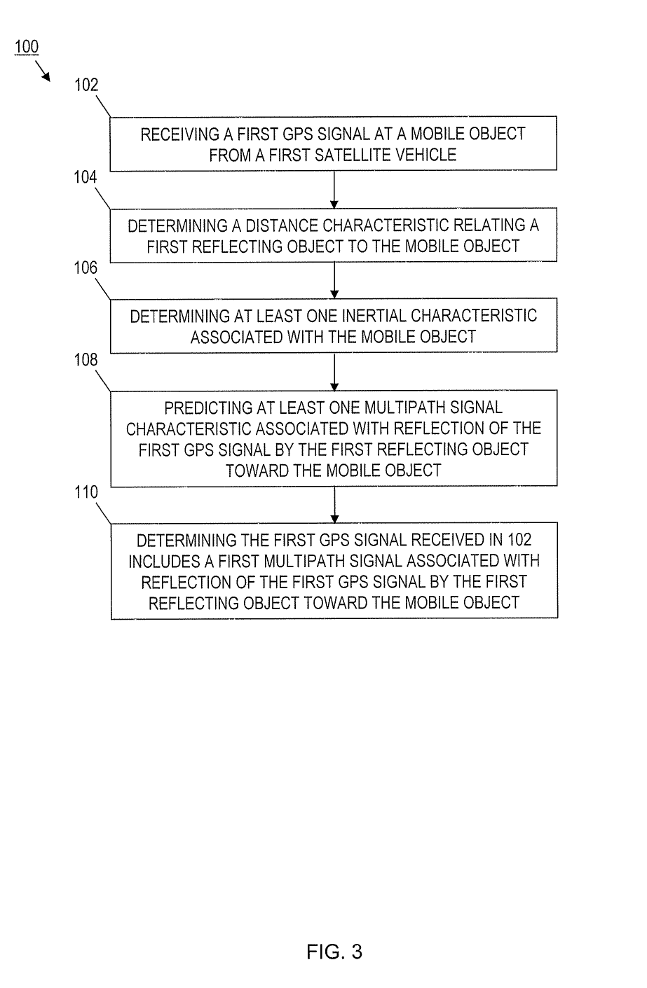

With reference to FIG. 3, an exemplary process 100 for identifying an exemplary multipath signal associated with an exemplary GPS signal begins at 102 where a first GPS signal from a first satellite vehicle is received at a mobile object. Next, a distance characteristic relating a first reflecting object to the mobile object is determined (104). At 106, at least one inertial characteristic associated with the mobile object is determined. Next, at least one multipath signal characteristic associated with reflection of the first GPS signal by the first reflecting object toward the mobile object is predicted (108). At 110, the process determines that the first GPS signal received in 102 includes a first multipath signal associated with reflection of the first GPS signal by the first reflecting object toward the mobile object.

In another embodiment, the mobile object may be moving during at least 102, 104, and 106. In yet another embodiment, the at least one inertial characteristic determined in 106 may include at least one of pitch, roll, and velocity characteristics. In still another embodiment, the determining in 104 may be based at least in part on a first model of the first reflecting object represented in a previously-generated digital map of an operational environment in which the mobile object is located. In still yet another embodiment, the determining in 104 may be based at least in part on a first measured parameter associated with a distance between the first reflecting object and the mobile object. In another embodiment, the predicting in 108 may be based at least in part on at least one of the distance characteristic determined in 104 and at least one inertial characteristic determined in 106. In still another embodiment, the determining in 110 may be based at least in part on at least one multipath signal characteristic predicted in 108.

The various aspects of FIG. 3 described above may be automated, semi-automated, or manual and may be implemented through hardware, software, firmware, or combinations thereof.

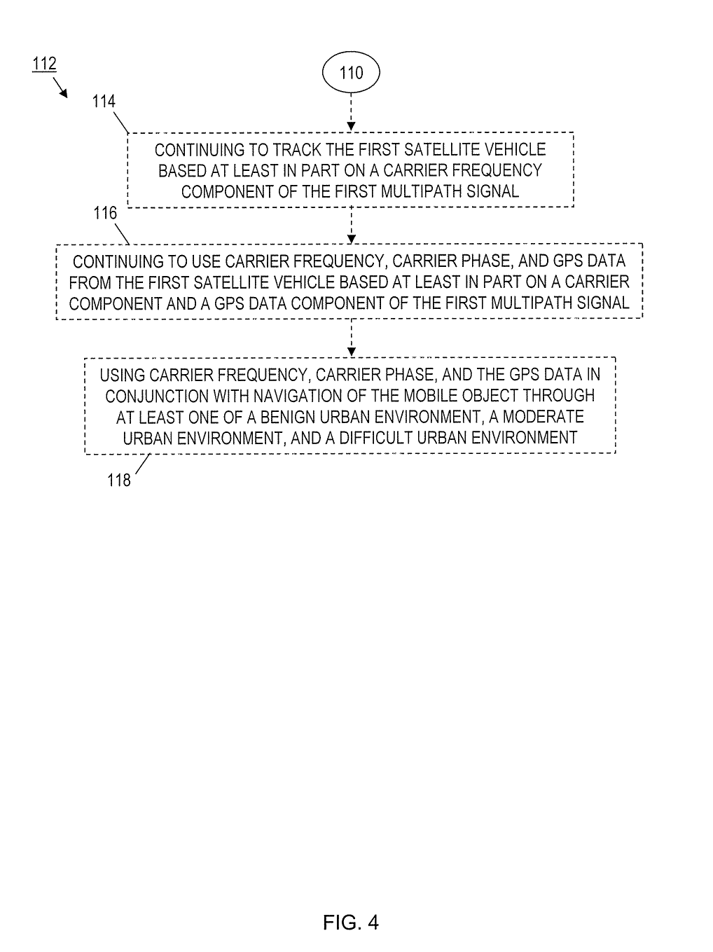

With reference to FIG. 4, an exemplary process 112 for constructively using an exemplary multipath signal associated with an exemplary GPS signal includes FIG. 3 and continues with 114 where tracking of the first satellite vehicle may continue based at least in part on a carrier frequency component of the first multipath signal. Next, use of carrier frequency, carrier phase, or GPS data from the first satellite vehicle in any combination may continue based at least in part on at least one of a GPS carrier component and a GPS data component of the first multipath signal (116). At 118, the carrier frequency, carrier phase, or GPS data may be used in any combination in conjunction with navigation of the mobile object through at least one of a benign urban environment, a moderate urban environment, and a difficult urban environment.

The various aspects of FIG. 4 described above may be automated, semi-automated, or manual and may be implemented through hardware, software, firmware, or combinations thereof.

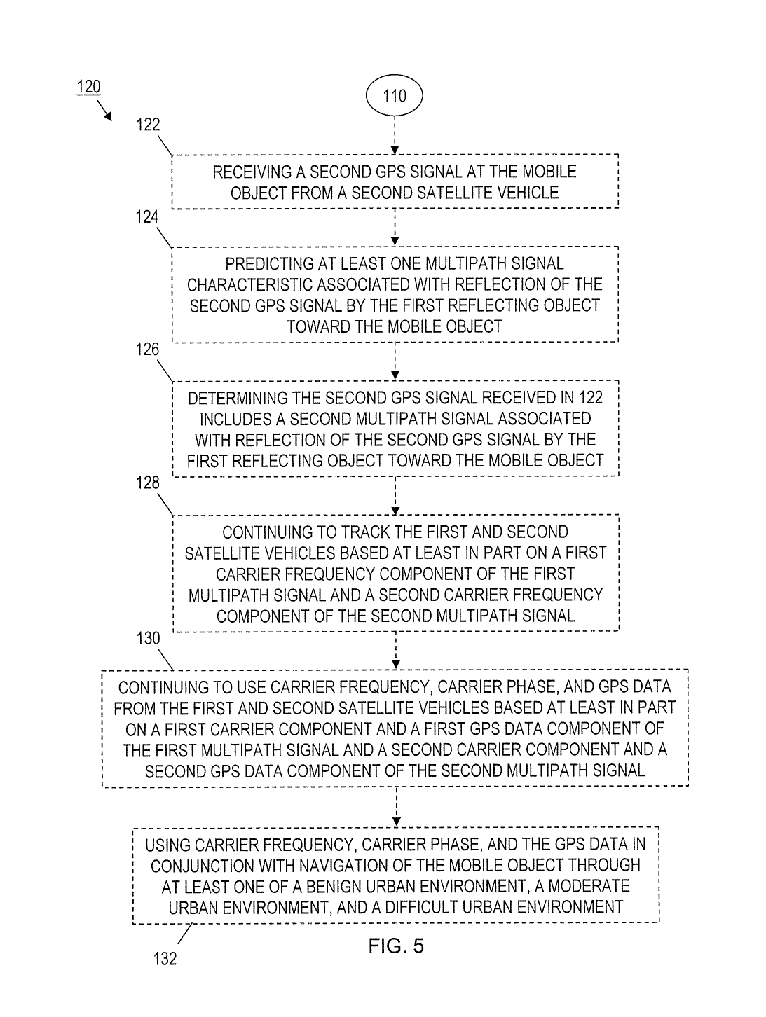

With reference to FIG. 5, an exemplary process 120 for constructively using several exemplary multipath signals associated with several corresponding exemplary GPS signals includes FIG. 3 and continues with 122 where a second GPS signal from a second satellite vehicle may be received at the mobile object. Next, at least one multipath signal characteristic associated with reflection of the second GPS signal by the first reflecting object toward the mobile object may be predicted (124). At 126, the process may determine that the second GPS signal received in 122 includes a second multipath signal associated with reflection of the second GPS signal by the first reflecting object toward the mobile object. Next, tracking of the first and second satellite vehicles may continue based at least in part on a first carrier frequency component of the first multipath signal and a second carrier frequency component of the second multipath signal (128). At 130, use of carrier frequency, carrier phase, or GPS data from the first and second satellite vehicles in any combination may continue based at least in part on at least one of a first GPS carrier component and a first GPS data component of the first multipath signal and at least one of a second GPS carrier component and a second GPS data component of the second multipath signal. Next, the carrier frequency, carrier phase, or GPS data may be used in any combination in conjunction with navigation of the mobile object through at least one of a benign urban environment, a moderate urban environment, and a difficult urban environment (132).

The various aspects of FIG. 5 described above may be automated, semi-automated, or manual and may be implemented through hardware, software, firmware, or combinations thereof.

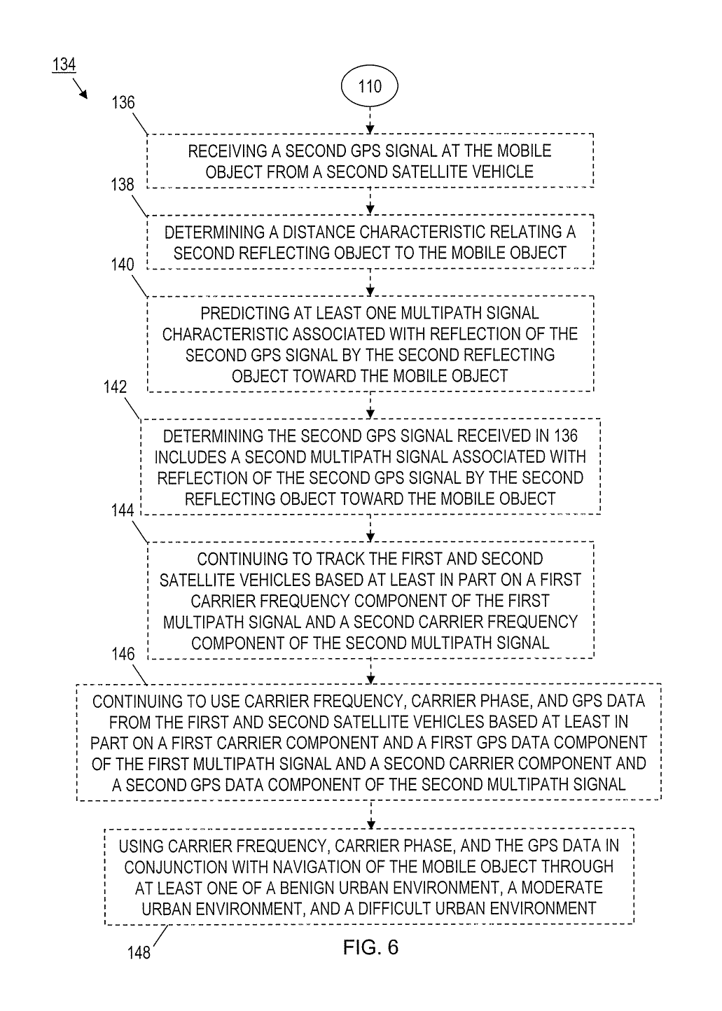

With reference to FIG. 6, another exemplary process 134 for constructively using several exemplary multipath signals associated with several corresponding exemplary GPS signals includes FIG. 3 and continues with 136 where a second GPS signal from a second satellite vehicle may be received at the mobile object. Next, a distance characteristic relating a second reflecting object to the mobile object may be determined (138). At 140, at least one multipath signal characteristic associated with reflection of the second GPS signal by the second reflecting object toward the mobile object may be predicted. Next, the process may determine that the second GPS signal received in 136 includes a second multipath signal associated with reflection of the second GPS signal by the second reflecting object toward the mobile object (142). At 144, tracking of the first and second satellite vehicles may continue based at least in part on a first carrier frequency component of the first multipath signal and a second carrier frequency component of the second multipath signal. Next, use of carrier frequency, carrier phase, or GPS data from the first and second satellite vehicles in any combination may continue based at least in part on at least one of a first GPS carrier component and a first GPS data component of the first multipath signal and at least one of a second GPS carrier component and a second GPS data component of the second multipath signal (146). At 148, the GPS data may be used in conjunction with navigation of the mobile object through at least one of a benign urban environment, a moderate urban environment, and a difficult urban environment.

In another embodiment, the determining in 138 may be based at least in part on a second model of the second reflecting object represented in a previously-generated digital map of an operational environment in which the mobile object is located. In yet another embodiment, the determining in 138 may be based at least in part on a second measured parameter associated with a distance between the second reflecting object and the mobile object.

The various aspects of FIG. 6 described above may be automated, semi-automated, or manual and may be implemented through hardware, software, firmware, or combinations thereof.

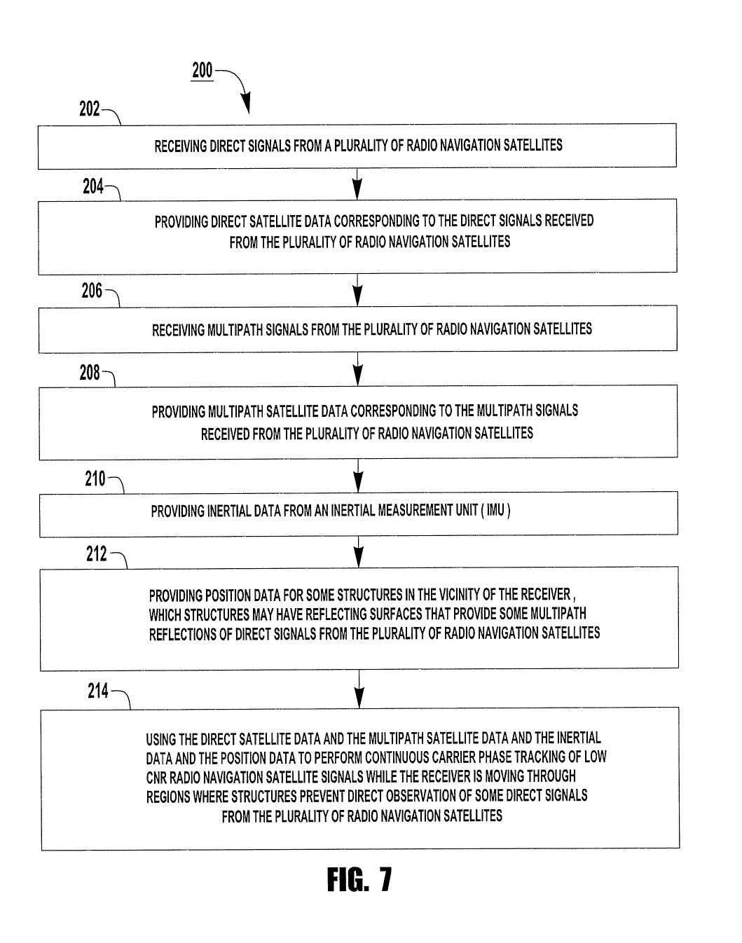

With reference to FIG. 7, an exemplary process 200 for using signals from a plurality of radio navigation satellites while a receiver is mobile begins at 202 where direct signals from the plurality of radio navigation satellites may be received. Next, direct satellite data corresponding to the direct signals received from the plurality of radio navigation satellites may be provided (204). At 206, multipath signals from the plurality of radio navigation satellites may be received. Next, multipath satellite data corresponding to the multipath signals received from the plurality of radio navigation satellites may be provided (208). At 210, inertial data from an inertial measurement unit (IMU) may be provided. Next, position data for some structures in the vicinity of the receiver may be provided (212). Such structures may have reflecting surfaces that may provide some multipath reflections of direct signals from the plurality of radio navigation satellites to the receiver. At 214, the direct satellite data, multipath satellite data, inertial data, and position data may be used to perform continuous carrier phase tracking of low CNR radio navigation satellite signals while the receiver is moving through regions where structures prevent direct observation of some direct signals from the plurality of radio navigation satellites.

In another embodiment, 212 may include using a distance measurement sensor to provide position data about reflecting surfaces in the vicinity of the receiver in real time. In yet another embodiment, 212 may include providing stored, predetermined position data about reflecting surfaces in a region and accessing the stored, predetermined position data for some structures in the vicinity of the receiver within the region in real time. In still another embodiment, 214 may include using multipath satellite data for radio navigation satellites having signals not being directly received by the receiver and using direct satellite data for radio navigation satellites having signals being directly received.

The various aspects of FIG. 7 described above may be automated, semi-automated, or manual and may be implemented through hardware, software, firmware, or combinations thereof.

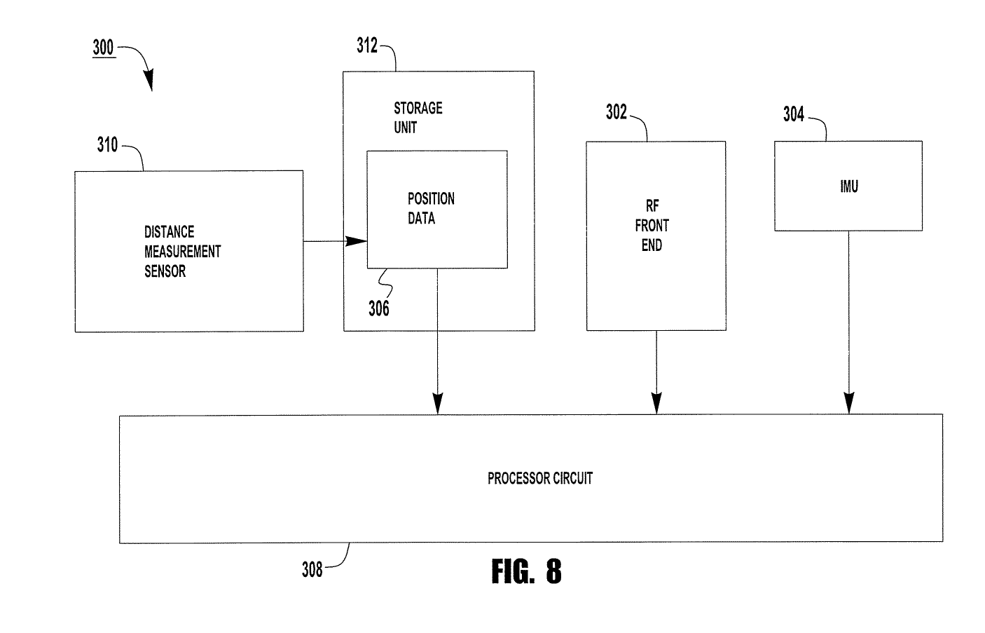

With reference to FIG. 8, an exemplary embodiment of a receiver 300 for using low carrier-to-noise ratio (CNR) signals from a plurality of radio navigation satellites while the receiver is mobile which may include a radio frequency (RF) front-end 302, an inertial measurement unit (IMU) 304, position data 306, and a processor circuit 308. The RF front-end 302 may provide satellite data corresponding to signals received directly from some of the plurality of radio navigation satellites. The RF front-end 302 may also provide multipath data corresponding to multipath signals received from some of the plurality of radio navigation satellites. The IMU 304 may provide inertial data. The position data 306 may include information for some structures in the vicinity of the receiver 300. Such structures may have reflecting surfaces that may provide some multipath reflections of the signals from the plurality of radio navigation satellites. Direct signals are typically not low CNR signals (e.g., between 12 and 32 dB-Hz), while multipath signals are expected to be low CNR signals. However, direct signals certainly could be low CNR signals and multipath signals certainly may be above the low CNR range. The processor circuit 308 may be in circuit communication with the RF front end 302 and IMU 304. The processor circuit 308 may be capable of using the satellite data, multipath data, inertial data, and position data to perform continuous carrier phase tracking of radio navigation satellite signals, including low CNR multipath signals, while the receiver is moving through regions where structures prevent direct observation of some signals from the plurality of radio navigation satellites.

In another embodiment, the receiver 300 may include a distance measurement sensor 310 to provide position data 306 about reflecting surfaces in the vicinity of the receiver 300 in real time. In yet another embodiment, the receiver 300 may include a storage unit 312 for storing predetermined position data 306 about reflecting surfaces in a region. In this embodiment, the processor circuit 308 may access the predetermined position data 306 for some structures in the vicinity of the receiver within the region in real time. In still another embodiment, the processor circuit 308 may use multipath data for radio navigation satellites having signals not being directly received by the receiver 300 and may use satellite data for radio navigation satellites having signals being directly received.

The various aspects of FIG. 8 described above may be automated, semi-automated, or manual and may be implemented through hardware, software, firmware, or combinations thereof.

The various embodiments of methods and apparatus disclosed herein allow one to use multipath reflections in a GPS receiver architecture for navigation solution tasks such as attitude, velocity, position, and time estimation, and inertial calibration. Notably, multipath reflections are not attenuated, filtered, or eliminated as is done by most conventional GPS receivers. Instead, these reflections may be used for navigation purposes. In order to use multipath reflections in GPS receiver architecture, multipath signal processing may be separated from processing of direct GPS signals. In urban environments, multipath signals are commonly reflected by objects that are within a close proximity of a GPS receiver. As a result, the propagation delay between multipath and direct signals normally stays below the length of the GPS coarse acquisition (CA) code chip (300 m, approximately). Therefore, separation of direct and multipath signals using the code phase difference may be fairly difficult. On the other hand, one finds that instantaneous frequencies of multipath signals received by a mobile user can differ significantly from the instantaneous frequency of the direct path signal. These differences are primarily due to: i) the non-zero receiver velocity and ii) significantly different line-of-sight (LOS) vectors from the satellite vehicle (SV) and the reflecting object to the receiver. As a result, frequency separation of direct and multipath signals can be utilized for independent processing of direct and multipath signals and subsequent use of multipath reflections in a navigation processor.

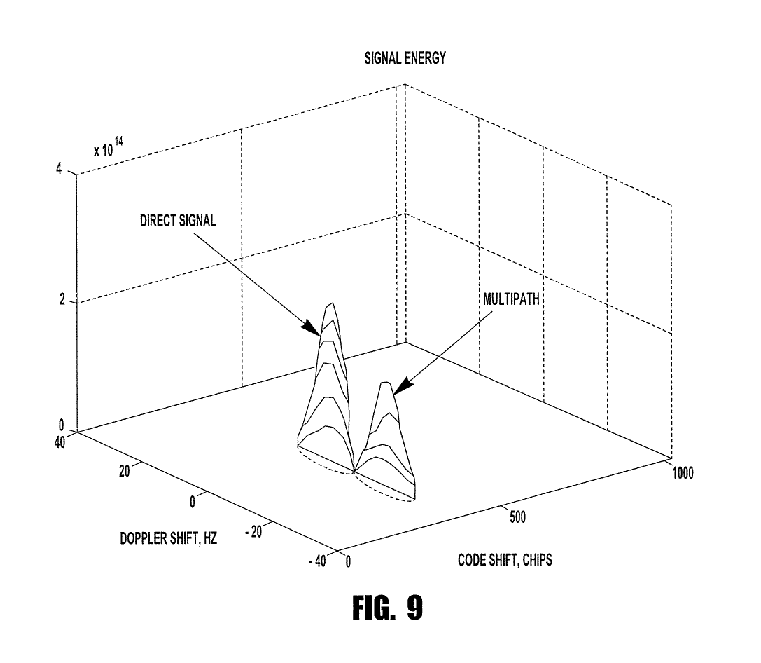

When processed by low CNR GPS acquisition and tracking modules, the direct path signal energy peak may be readily distinguishable from the multipath signal peak(s) as illustrated in FIG. 9. The signal energy function shown in FIG. 9 may be computed using systems and methods for acquisition and tracking of low-CNR GPS signals that are applied to mobile GPS data collected in an urban canyon. The energy function may be represented as a three-dimensional (3D) signal image with the Doppler carrier frequency shift along the x-axis, code phase shift along the y-axis, and signal energy along the z-axis. FIG. 9 demonstrates a multipath energy peak that is clearly distinguishable from the direct signal energy peak. For additional detail on processing low CNR GPS signals see U.S. Pat. App. Pub. No. 2006/0071851 to van Graas et al., the contents of which are fully incorporated herein by reference.

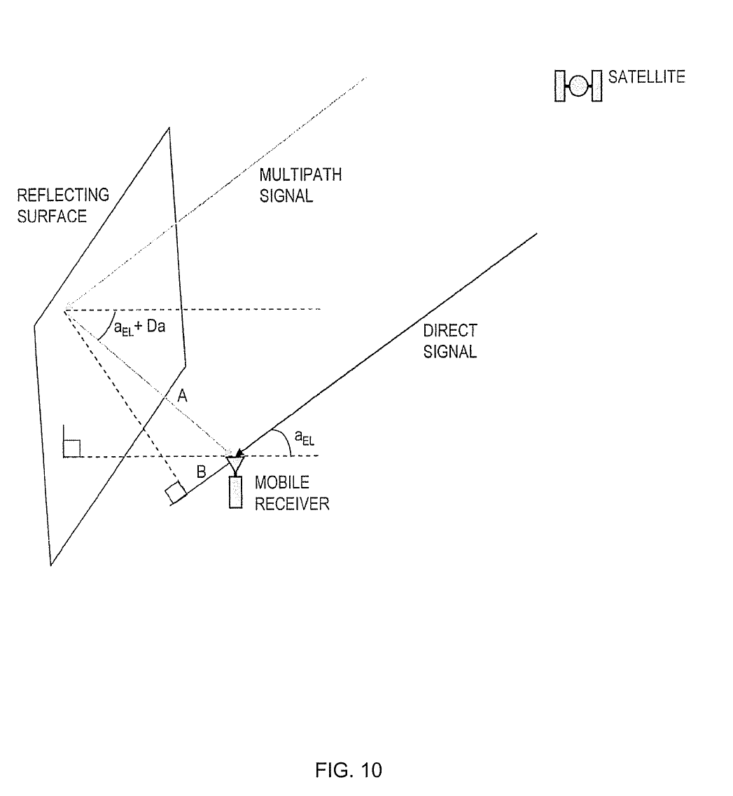

With reference to FIG. 10, an exemplary geometry of the direct and multipath propagation paths is shown. FIG. 10 considers the case where the multipath signal is reflected from a vertical planar surface. Since most of multipath signals are reflected by vertical building walls in structured urban environments, the building walls can be approximated as vertical planes. In FIG. 10, a_{EL} (α_{EL}) is the satellite elevation angle and Da (Δα) is the angular deviation of multipath reflection from the direction of specular reflection for which the angle of incidence equals the angle of reflection. Receiver/satellite line-of-site (LOS) vector and reflector/satellite LOS vector may be approximated as parallel since the distance from the receiver to the reflector is significantly smaller than the distance from the receiver to the satellite. The difference between the direct and multipath propagation paths represented in FIG. 10 may be formulated as follows:

Δρ=ρ_{MP}−ρ_{D}=A+B (1),

where ρ_{D} is the direct signal propagation path and ρ_{MP} is the multipath propagation path.

From the geometry presented in FIG. 10, the values of A and B may be computed as follows:

$$A = {ρ}_{Mobile / Plane} \cdot \frac{1}{cos ( {α}_{EL} + Δ α )} \\ B = {ρ}_{Mobile / Plane} \cdot \frac{cos ( 2 {α}_{EL} + Δ α )}{cos ( {α}_{EL} + Δ α )} , \qquad ( 2 )$$

where ρ_{Mobile/Plane} is the distance from the mobile object (or mobile receiver of GPS signals) to the reflecting planar surface. This distance can be expressed as follows:

ρ_{Mobile/Plane}=(R_{rcvr},nₚₗₐₙₑ)−ρ_{Plane} (3),

where (R_{rcvr},nₚₗₐₙₑ) is the vector dot product; R_{rcvr} is the position vector of the mobile object with vector components resolved in a navigation frame (for instance, local-level East-North-Up frame can be used as a navigation frame); and, ρ_{Plane} is the planar surface range, which equals the distance from the origin of the navigation frame to the planar surface.

Substituting equations (2) and (3) into equation (1) yields:

$$Δρ = [ ( {R}_{rcvr} , {n}_{plane} ) - {ρ}_{Plane} ] \cdot \frac{1 + cos ( 2 {α}_{EL} + Δ α )}{cos ( {α}_{EL} + Δα )} .$$

For the special case of specular reflection where Δα=0, equation (4) may be transformed as follows:

Δρ_{specular}=└(R_{rcvr},nₚₗₐₙₑ)−ρ_{Plane}┘·2·cos(α_{EL}) (5).

The difference in carrier frequencies between multipath and direct signals may be computed directly from equation (4) by differentiating over time and transforming differentiation results into the Doppler frequency shift domain. Correspondingly, equation (6) may be used to formulate the difference between carrier frequencies of the direct and multipath signals:

$$Δ f \approx - \frac{1}{λ} \cdot ( {V}_{rcvr} , {n}_{plane} ) \cdot \frac{1 + cos ( 2 {α}_{EL} + Δ α )}{cos ( {α}_{EL} + Δ α )} , \qquad ( 6 )$$

where V_{rcvr} is the velocity of the mobile object with velocity components resolved in the navigation frame and λ is the carrier wavelength. For the special case of specular reflection, equation (6) may be transformed as follows:

$$\begin{matrix}Δ {f}_{specular} \approx - \frac{2}{λ} \cdot ( {V}_{rcvr} , {n}_{plane} ) \cdot cos ( {α}_{EL} ) \\ = - \frac{2}{λ} \cdot ( {V}_{rcvr} , {n}_{plane} ) \cdot ( \frac{{R}_{SV}}{‖ {R}_{SV} ‖} , {n}_{plane} ) ,\end{matrix} \qquad ( 7 )$$

where ∥ ∥ denotes the absolute value and R_{SV} is the satellite position vector that can be computed from satellite ephemeris data.

Equations (6) and (7) neglect the component of frequency difference that is due to changes in the satellite elevation angle over time. Normally, for the specular reflection case, this component does not exceed 0.1 Hz for planar surfaces within a 100-m range of the mobile object. For those applications where a frequency estimation accuracy of better than 0.1 Hz is desired, equation (7) can be modified to include variations in the SV elevation angle. As stated previously, equations (6) and (7) are derived for the case where multipath signal is reflected from a vertical plane. For a more general case of non-vertical planar surfaces, equation (6) may be modified as follows:

$$Δ f \approx - \frac{1}{λ} \cdot ( {V}_{rcvr} , {n}_{plane} ) \cdot \frac{1 + cos ( 2 {α}^{′} + Δ α )}{cos ( {α}^{′} + Δα )} \\ {α}^{′} = arc cos ( \frac{{R}_{SV}}{‖ {R}_{SV} ‖} , {n}_{plane} ) . \qquad ( 8 )$$

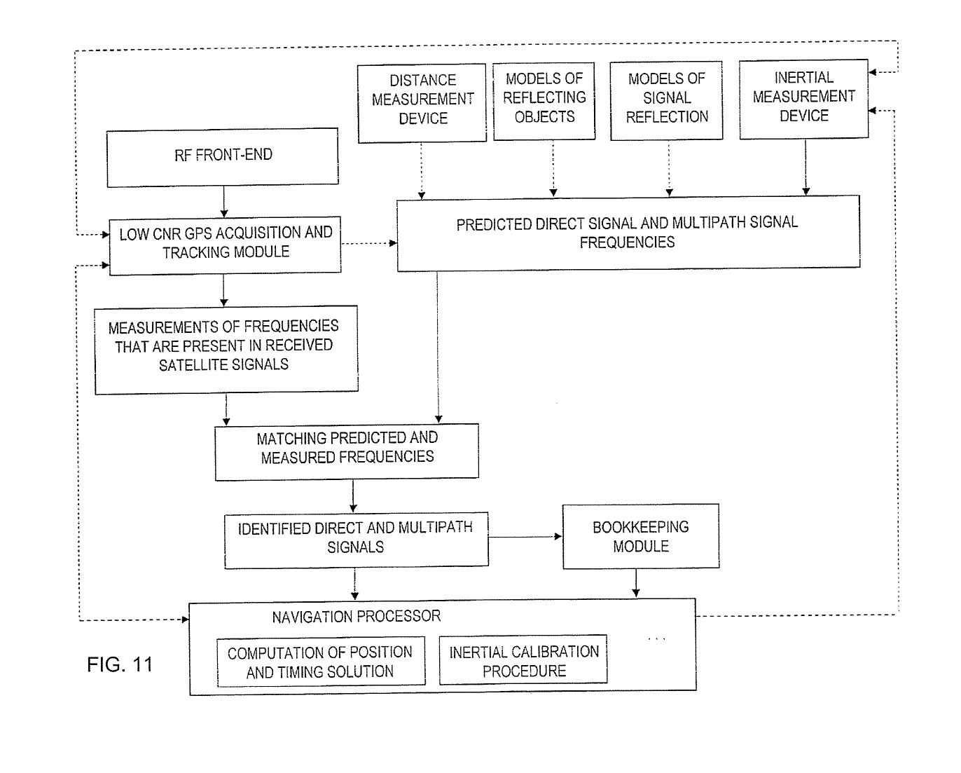

Equations (6) through (8) can be applied to predict differences between multipath and direct signal frequencies. Predicted frequency differences can be then exploited to identify direct and multipath signals in the received satellite signals. This process is illustrated in FIG. 11. Predicted multipath and direct signal frequencies can be computed using models of reflecting objects with model parameters extracted, for instance, from measurements of a distance measurement device or a digital map of surrounding buildings; models of signal reflections (e.g., diffuse reflection or specular reflection models); and, inertial measurements. Predicted multipath and direct signal frequencies can be matched to signal frequencies that are measured from the plurality of GPS satellite signals. Signal frequencies may be measured using low CNR acquisition and tracking methods that can apply inertial aiding of the GPS signal accumulation, and a local maxima search method disclosed below. Low CNR GPS signals may be acquired and tracked, for example, using any of the various systems or methods taught in U.S. Pat. App. Pub. No. 2006/0071851 to van Graas et al., the contents of which are fully incorporated herein by reference. Identified direct and multipath signals (i.e., signal whose measured frequencies match predicted frequencies) may be used by the navigation processor for tasks such as position and timing computations, and estimation of inertial correction terms in a GPS/INS integrated Kalman filter. The bookkeeping module may maintain tracking history of various direct and multipath tracking channels.

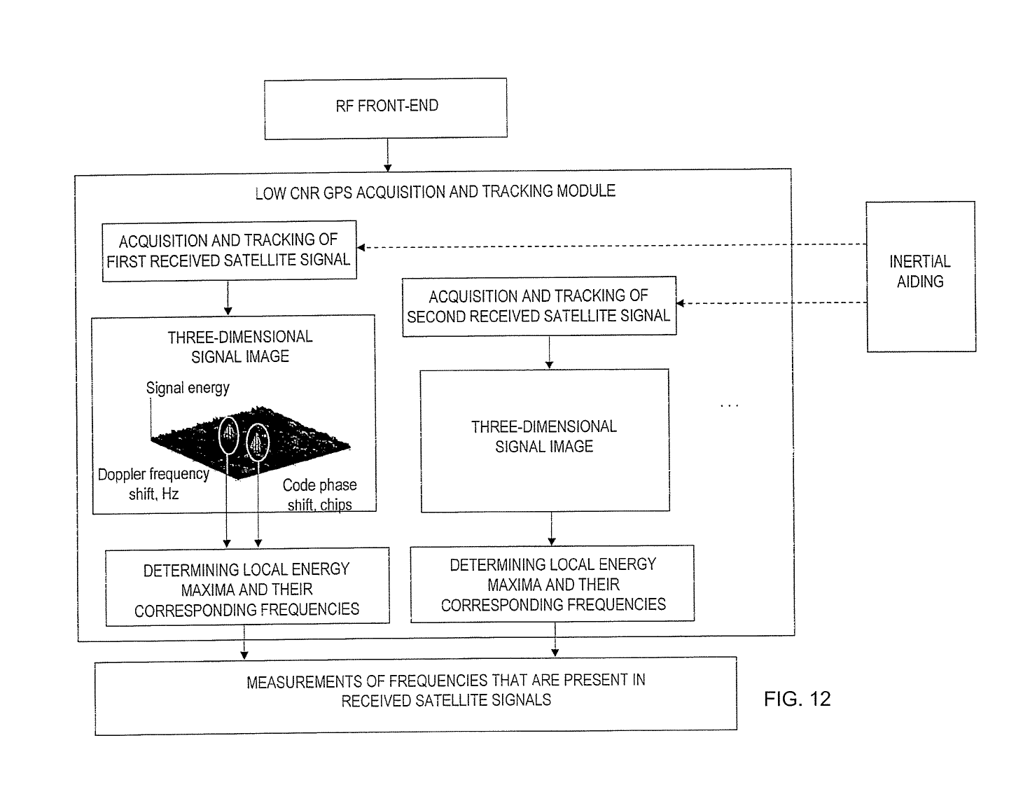

With reference to FIG. 12, an exemplary process of measuring frequencies present in received satellite signals is shown. A 3D satellite signal image or data structure may be constructed for the first received satellite signal. Local energy maxima that are present in the 3D signal image or data structure may be determined and their corresponding frequencies may be estimated. This process may be repeated for the other received satellite signals. Processing of different satellite signals can be performed both sequentially and in parallel depending on computational power requirements of a specific implementation of the method and apparatus disclosed herein. Construction of the 3D signal image or data structure may utilize systems and methods for processing of low CNR GPS signals, such as those taught in U.S. Pat. App. Pub. No. 2006/0071851 to van Graas et al.

The GPS signal image or data structure may be represented as a two-dimensional (2D) energy function E, where:

E={E(fₘ,τₖ)}={I²(fₘ,τₖ)+Q²(fₘ,τₖ)}

{fₘ}=[−Mₘₐₓ·Δf, . . . , Mₘₐₓ·Δf]

{τₖ}=[0, . . . , 1022]·T_{chip} (9),

where E, I, and Q are signal energy, in-phase, and quadrature signals, respectively, that are accumulated over the time interval T_{acm}. For processing of low CNR GPS signals (e.g., GPS signals with CNR in the range from 15 to 20 dB-Hz or lower), the value of T_{acm} may vary from 0.1 s to 1 s. In equation (9), {fₘ}, m=−Mₘₐₓ, . . . , Mₘₐₓ is the frequency search space for which the energy function is computed. As it can be inferred from equations (6) through (8), the frequency search space covers the interval

$$[ - \frac{2 \cdot ‖ {V}_{rcvr} ‖}{λ} , \frac{2 \cdot ‖ {V}_{rcvr} ‖}{λ} ]$$

in order to observe possible multipath signal frequencies. Also note that a second order polynomial fit may be applied to determine local energy maxima. For an efficient determination of local maxima, at least three samples of the energy function per frequency interval are desired. A frequency interval may correspond to the distance between consecutive nulls of the energy function in the frequency domain. For GPS signals, this distance may be

$$\frac{2}{{T}_{acm}} .$$

Hence, the frequency discrete Δf of the search space would be less than

$$Δ f < \frac{2}{3 {T}_{acm}} .$$

The {τₖ}, k=0, . . . , 1022 term in equation (9) is the code phase search space, which covers the duration of the CA-code period. Note that the energy function for different values of code phase can be computed in parallel. For additional detail on such parallel computations see U.S. Pat. App. Pub. No. 2006/0071851 to van Graas et al., the contents of which are fully incorporated herein by reference.

As stated previously, the difference between the code phase of multipath signals that are reflected from surrounding buildings in urban environments and the code phase of the direct signal generally does not exceed the duration of the CA-code chip (1 μs or, equivalently, 300 m). Therefore, the local maxima search can be limited to the code phase τₖ_{₀}, where

$${k}_{0} = {min}_{k} ‖ \hat{τ} - {τ}_{k} ‖ ,$$

k=0, . . . , 1022 and \hat{τ} is the estimate of the direct signal code phase that is obtained from the low CNR signal processing module. For additional detail on the low CNR signal processing module see U.S. Pat. App. Pub. No. 2006/0071851 to van Graas et al. Based on the foregoing, the local maxima search can be limited to the two-dimensional (2D) energy function E(fₘ,τₖ_{₀}), m=−Mₘₐₓ, . . . , Mₘₐₓ.

Note that in order to avoid energy losses that exceed 3 dB, a direct signal code phase estimate within half-the-chip of the CA code (150 m, approximately) and a difference between direct and multipath signal propagation paths not exceeding the half-the-chip duration is desired. For cases where these conditions do not exist, the local maxima search can be extended to other code phase values.

Local energy maxima may be determined as follows. First, the following energy subsets may be constructed:

$${E}_{subset} ( m ) = \{ E ( {f}_{p} , {τ}_{{k}_{0}} ) \} , \\ p = m - P , m + P , P = round ( \frac{1}{{T}_{acm} \cdot Δ f} ) \\ m = - {M}_{max} + P , … , {M}_{max} - P . \qquad ( 10 )$$

Second, for each subset, a second-order polynomial may be fitted through samples of the energy function using a least-mean-square (LMS) procedure. The LMS polynomial may be represented as follows:

E_{subset}(f)=C₀+C₁f+C₂f² (11).

Third, a local maximum may be determined. If the absolute maximum of the LMS polynomial corresponds to the subset central frequency, the following conditions may be satisfied:

$${C}_{2} < 0 \\ m = {min}_{p} ‖ - \frac{{C}_{1}}{2 {C}_{2}} - {f}_{p} ‖ , p = m - P , m + P . \qquad ( 12 )$$

If the above local maximum conditions are satisfied, a local maximum may be determined and its corresponding frequency may be estimated:

$$\hat{f} = - \frac{{C}_{1}}{2 {C}_{2}} . \qquad ( 13 )$$

Frequencies that correspond to local energy maxima determined in received satellite signals may serve as measurements of frequencies that are present in received satellite signals (see FIG. 12). In one embodiment, receiver and satellite motion may be removed from or reduced in the incoming GPS signal. For additional detail on removing or reducing receiver and satellite motion see U.S. Pat. App. Pub. No. 2006/0071851 to van Graas et al., the contents of which are fully incorporated herein by reference. Thus, the predicted direct signal frequency may correspond to the zero frequency in the 3D signal image. Multipath frequencies may be predicted as differences between the multipath and direct signal frequencies using, for example, equation (6) or equation (8).

For motion scenarios that involve non-zero acceleration profiles, frequency difference between multipath and direct signals can vary over time. To avoid energy losses, the energy accumulation process can be adjusted for frequency variations for those search frequencies fₘ whose values are close to a predicted multipath frequency. Particularly, accumulated in-phase and quadrature signals (I and Q signals) can be adjusted as follows:

$${I}^{adj} ( {f}_{m} , {τ}_{{k}_{0}} , {t}_{n} ) = I ( {f}_{m} , {τ}_{{k}_{0}} , {t}_{n} ) \cdot cos ( {Δϕ}^{adj} ( {t}_{n} ) ) + Q ( {f}_{m} , {τ}_{{k}_{0}} , {t}_{n} ) \cdot sin ( {Δϕ}^{adj} ( {t}_{n} ) ) \\ {Q}^{adj} ( {f}_{m} , {τ}_{{k}_{0}} , {t}_{n} ) = - I ( {f}_{m} , {τ}_{{k}_{0}} , {t}_{n} ) \cdot sin ( {Δϕ}^{adj} ( {t}_{n} ) ) + Q ( {f}_{m} , {τ}_{{k}_{0}} , {t}_{n} ) \cdot cos ( {Δϕ}^{adj} ( {t}_{n} ) ) \\ {Δϕ}^{adj} ( {t}_{n} ) \approx - \frac{2 π}{λ} \cdot ( {Δ}_{a} {R}_{rcvr} ( {t}_{n} ) , {n}_{plane} ) \cdot \frac{1 + cos ( 2 {α}^{′} + Δα )}{cos ( {α}^{′} + Δα )} \\ {Δ}_{a} {R}_{rcvr} ( {t}_{n} ) = {\int }_{{t}_{0}}^{{t}_{n}} {\int }_{{t}_{0}}^{{t}_{2}} {a}_{rcvr} ( {t}_{1} ) \cdot d {t}_{1} \cdot d {t}_{2} \\ {t}_{n} = {t}_{0} + n \cdot Δ t \qquad ( 14 )$$

where t₀ corresponds to the beginning of the signal accumulation interval; Δt is the time discrete of adjusting I and Q accumulated signals for frequency variations; and, ΔₐR_{rcvr} is the component of the receiver position vector increment that is due to non-zero receiver acceleration (this component can be derived from inertial measurements).

I and Q values may be adjusted if the search frequency fₘ is close to a predicted multipath frequency. For example, if the following condition is satisfied:

$$‖ {f}_{m} + \frac{1}{λ} \cdot ( {V}_{rcvr} ( {t}_{0} ) , {n}_{plane} ) \cdot \frac{1 + cos ( 2 {α}^{′} + Δα )}{cos ( {α}^{′} + Δα )} ‖ \leq \frac{1}{{T}_{acm}} . \qquad ( 15 )$$

For reliable carrier phase tracking of multipath reflections, it is preferred that the choice of the time discrete Δt fits the following criterion:

$$‖ ( {a}_{rcvr} \frac{Δ {t}^{2}}{2} , {n}_{plane} ) \cdot \frac{1 + cos ( 2 {α}^{′} + Δα )}{cos ( {α}^{′} + Δα )} ‖ \leq 1 cm . \qquad ( 16 )$$

Hence, for those cases where Δt<T_{acm}, the signal accumulation process collects accumulated I and Q values after each Δt interval. Next, these Is and Qs may be adjusted for the receiver acceleration as specified by equation (14). Finally, signal energy accumulated over the entire accumulation interval T_{acm} may be computed as follows:

$$E ( {f}_{m} , {τ}_{k} ) = {( {\sum }_{n} {I}^{adj} ( {f}_{m} , {τ}_{k} , {t}_{n} ) )}^{2} + {( {\sum }_{n} {Q}^{adj} ( {f}_{m} , {τ}_{k} , {t}_{n} ) )}^{2} . \qquad ( 17 )$$

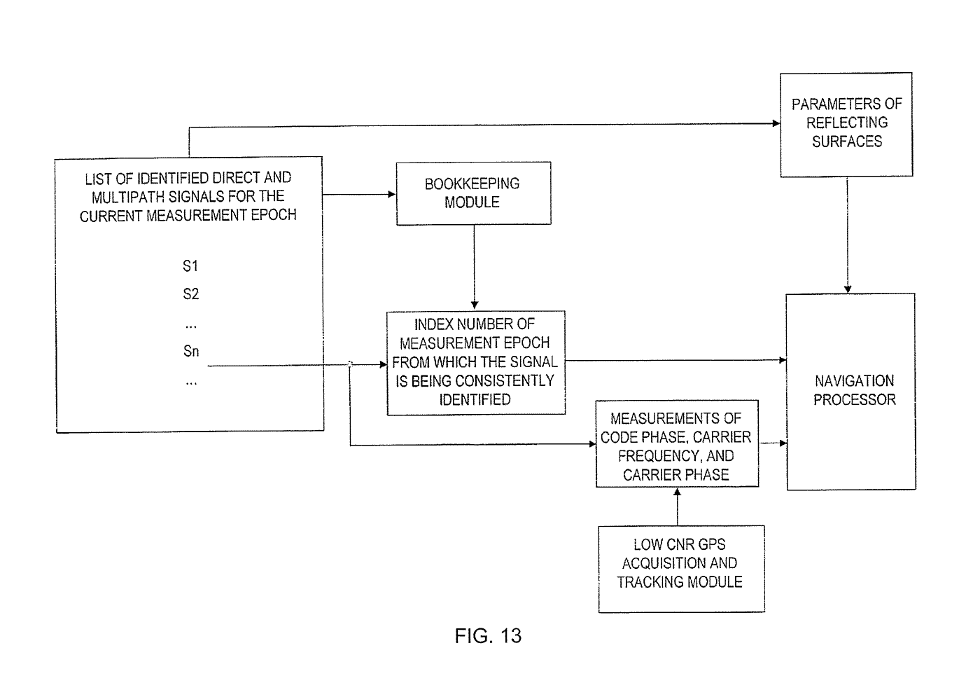

Measured signal frequencies may be matched to predicted frequencies of direct and multipath satellite signals (see FIG. 11). As a result, a list of matched direct and multipath signals may be created. This list may be used for navigation processing tasks as shown in FIG. 13. GPS signal measurements (i.e., measurements of code phase, carrier frequency, and carrier phase) for identified signals may be obtained from the low CNR acquisition and tracking processing module. For example, accumulated I and Q values that correspond to a local energy maximum that is identified as a direct signal or a multipath signal can be applied to obtain carrier phase measurements, while carrier frequency measurements can be computed using equation (13). Signal parameter measurements may be used by the navigation processor that performs tasks such as computation of position, velocity and time solution, and inertial calibration.

The bookkeeping module may maintain a tracking status matrix, where each matrix row corresponds to a particular multipath or direct signal channel and each column corresponds to a particular measurement epoch. For each measurement epoch, the module may assign “1” to the matrix element if its associated signal is identified and otherwise may assign “0”. The tracking status matrix may be used, for example, to determine how long a consistent carrier phase tracking has been maintained for a particular signal channel. Signals that are identified over at least two consecutive measurement epochs can be used for carrier phase-based positioning methods. For additional information on carrier phase-based positioning methods, see, for example, Kaplan et al., (Editors), Understanding GPS: Principles and Applications, 2nd ed., Artech House Publishers (2005), the contents of which are fully incorporated herein by reference. If only one measurement epoch is available for a particular signal, its corresponding carrier frequency and code phase measurements can be used. Note that velocity and position computations use measurements of identified multipath signals and frequency and range measurement models for the corresponding multipath signals. These models are exemplified by equations (4) and (6). Measurement model parameters that are related to reflecting surfaces (for instance, plane range and normal vector in equation (9)) can be estimated, for example, using measurements of a distance measurement device.

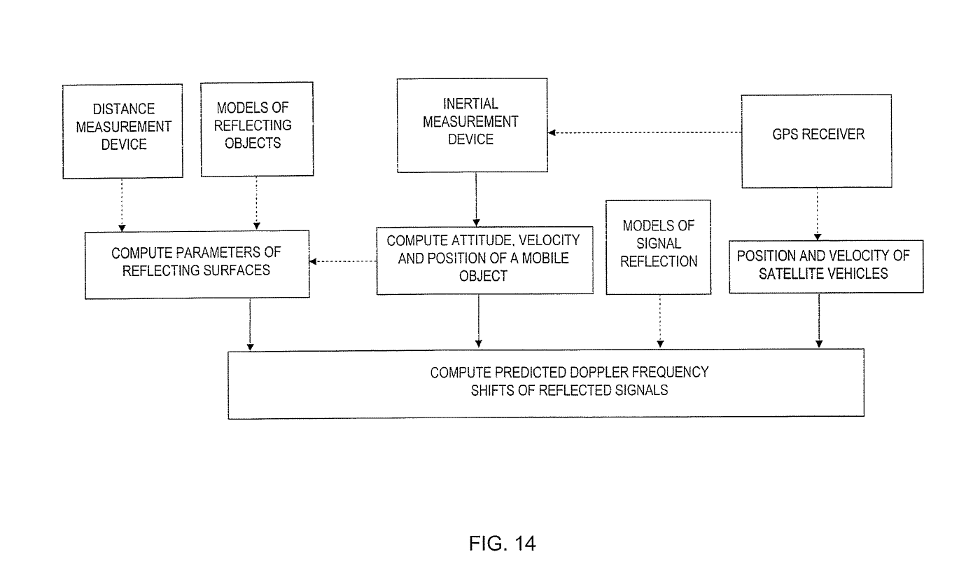

With reference to FIG. 14, an exemplary process for computing predicted frequencies of reflected signals is shown. Predicted multipath frequencies may be computed based on parameters of reflecting surfaces, velocity of a mobile object, and position and velocity of satellite vehicles. Computation of predicted multipath frequencies can also exploit models of signal reflections such as specular of diffuse reflection models. Estimation of parameters of reflecting surfaces can use measurements of a distance measurement device (such as a laser scanner), models of reflecting surfaces (such as a vertical planar surface), and inertial measurements (for example, inertial attitude can be applied to compensate for the tilt of laser scanning plane and inertial position can be applied to transform estimated ranges of a planar surfaces from a body-frame of the distance measurement device into a navigation frame). The inertial measurement device may provide estimates of mobile object velocity that may be used to compute predicted multipath frequencies. GPS receiver outputs (such as outputs of a GPS receiver that uses systems and methods for acquisition and tracking of low CNR GPS signals) can be exploited to periodically calibrate an inertial measurement device in order to reduce drift in inertial navigation outputs. For additional detail on acquisition and tracking of low CNR GPS signals see U.S. Pat. App. Pub. No. 2006/0071851 to van Graas et al., the contents of which are fully incorporated herein by reference.

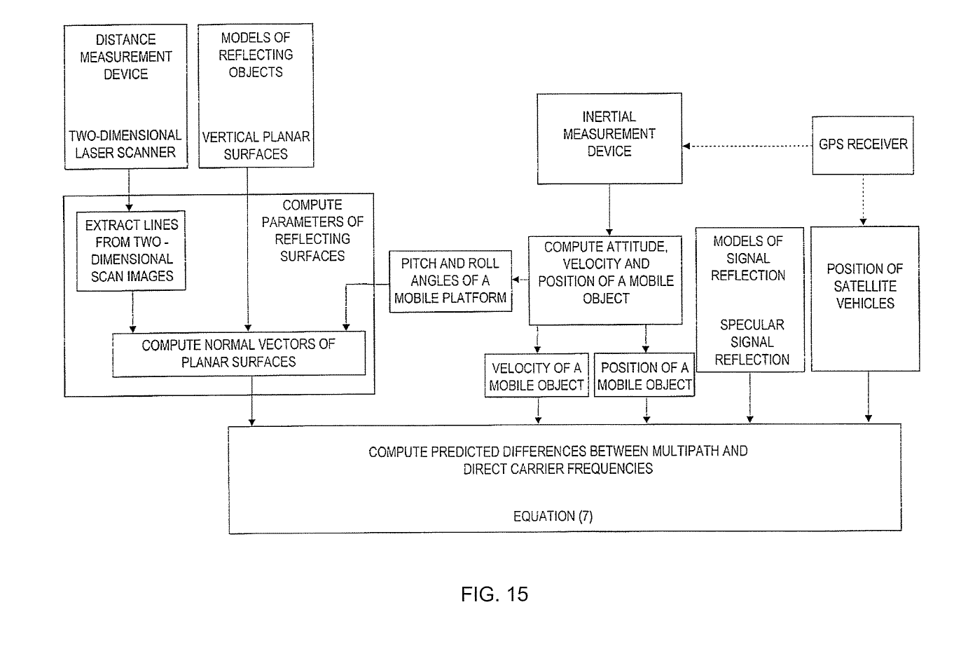

With reference to FIG. 15, an exemplary process for prediction of reflected multipath signals is shown where a two-dimensional (2D) laser scanner may be used to measure parameters of reflecting surfaces. Reflecting surfaces may be approximated by vertical planes. A specular reflection model may be utilized to predict multipath frequencies. In this case, the computation of differences between direct and multipath carrier frequencies may use equation (7). In equation (7), normal vectors of vertical planes may be estimated based on parameters of lines extracted from 2D laser scan images that are adjusted for the scanner tilt using inertial measurements of pitch and roll angles and mobile object velocity may be provided by the inertial measurement device using GPS receiver measurements for mitigation of velocity drift.

An exemplary procedure to compensate for the laser scanner tilt is described below. The tilt compensation procedure may use estimates of platform tilt angles (pitch and roll) provided by the INS to computationally rotate a tilted scan image into a horizontal scan frame. This computational rotation procedure may estimate line parameters in the horizontal scan (i.e., computed scan) based on line parameters that may be extracted from a tilted scan (i.e., measured scan) using standard line extraction procedures such as those described in, for example, Nguyen et al., A Comparison of Line Extraction Algorithms using 2D Laser Rangefinder for Indoor Mobile Robotics, IEEE International Conference on Intelligent Robots and Systems, IROS 2005, Edmonton, Canada, Aug. 2-6, 2005, the contents of which are fully incorporated herein by reference. The computational rotation may be derived by considering intersections of a vertical planar surface with horizontal and tilted scan planes.

The derivation of the rotation procedure, for example, includes the following general equation of a planar surface in three dimensions:

x·cos(α)·cos(θ)+y·sin(α)·cos(θ)+z·sin(θ)=ρ (18),

where x, y, and z are coordinates of a point on the plane, ρ is the plane range, α is the plane azimuth angle, and θ is the plane tilt angle. Vertical planes for which θ=0 may be assumed for purposes of this example. The vertical plane assumption may be applied since indoor and outdoor urban environments typically include planar surfaces created by vertical building walls. Accordingly, a vertical plane equation at the (x,y,z) frame may be expressed as follows:

x·cos(α)+y·sin(α)=ρ (19).

Intersection of a planar surface with a horizontal scan plane (x,y) may be derived by setting z=0, Since z is absent in the plane formulation of equation (18), the intersection line equation may be defined by equation (19). Equation (19) is an example of a line equation that uses polar parameters to represent the line. Therefore, ρ and α may serve as line polar parameters in the non-tilted scan frame (x,y).

A plane equation may be expressed in the tilted frame (x′,y′,z′) in order to derive the intersection line equation for the tilted scan frame. A coordinate transformation from tilted (x′,y′,z′) to the non-tilted frame (x,y,z) may be defined as follows:

$$[ \begin{matrix}x \\ y \\ z\end{matrix} ] = C \cdot [ \begin{matrix}{x}^{′} \\ {y}^{′} \\ {z}^{′}\end{matrix} ] , \qquad ( 20 )$$

where C=C_{(x′,y′,z′)}^{(x,y,z)} is the coordinate transformation matrix from the tilted frame (x′,y′,z′) to the non-tilted frame (x,y,z). The coordinate transformation matrix may be derived from inertial data. Particularly, the relative navigation frame (N-frame) may be used as a non-tilted frame for the exemplary implementation considered herein. A tilted frame may be represented by the current scan frame, which is an example of a platform body frame (b-frame). The matrix C thus corresponds to a body/navigation frame direction cosine matrix C_{b}^{N}. The direction cosine matrix C_{b}^{N} may be used by inertial systems to characterize the attitude and may be computed by integrating inertial gyro outputs.

Performing matrix multiplications in equation (20) and substituting multiplication results into equation (19) yields the following equation:

x′·(C₁₁·cos(α)+C₂₁·sin(α))+y′·(C₁₂·cos(α)+C₂₂·sin(α))+z′·(C₁₃·cos(α)+C₂₃·sin(α))=ρ (21).

The equation provides the vertical planar surface represented in the tilted coordinate frame. The vertical planar surface may intersect with the tilted scan plane (x′, y′) at z′=0.

Thus, the intersection line equation may be expressed as follows:

x′·(C₁₁·cos(α)+C₂₁·sin(α))+y′·(C₁₂·cos(A)+C₂₂·sin(α))=ρ (22).

When the same line is extracted from the tilted scan image it has the following representation:

x′·cos(α′)+y′·sin(α·)=ρ′ (23),

where ρ′ and α′ are parameters of the intersection line normal point in the tilted frame. Note that equations (22) and (23) express the same line using parameters of the normal points for line intersections with horizontal and tilted scan planes, correspondingly. These equations can be thus applied to relate normal point parameters in horizontal and tilted scan images.

Using equation (22) for a line point for which y′=0 provides the following:

$${y}^{′} = 0 ⇒ {x}^{′} = \frac{ρ}{( {C}_{11} \cdot cos ( α ) + {C}_{21} \cdot sin ( α ) )} . \qquad ( 24 )$$

Similarly, using equation (23) for a line point for which y′=0 provides the following:

$${y}^{′} = 0 ⇒ {x}^{′} = \frac{{ρ}^{′}}{cos ( {α}^{′} )} . \qquad ( 25 )$$

A comparison of equations (24) and (25) provides the following:

$$\begin{matrix}\frac{ρ}{( {C}_{11} \cdot cos ( α ) + {C}_{21} \cdot sin ( α ) )} = \frac{{ρ}^{′}}{cos ( {α}^{′} )} , \\ or \text{:} & ( 26 ) \\ {ρ}^{′} \cdot ( {C}_{11} \cdot cos ( α ) + {C}_{21} \cdot sin ( α ) ) - ρ \cdot cos ( {α}^{′} ) = 0. & ( 27 )\end{matrix}$$

Similar considerations can be performed by analyzing equations (22) and (23) for a line point for which x′=0. The following expression is derived for this case:

ρ′·(C₁₂·cos(α)+C₂₂·sin(α))−ρ·sin(α′)=0 (28).

Equations (27) and (28) provide a system of non-linear equations for the estimation of line parameters in the horizontal scan frame (ρ and α) based on line parameters (ρ′ and α′) that are extracted from laser measurements in a tilted scan frame. This system may be solved iteratively by applying linearizations. The system may be linearized around the previous estimates of range and angle for each iteration. Adjustments to the previous estimates may be computed through the solution of linear equation systems. To start iterations, initial estimates may be obtained as follows:

$$\hat{ρ} = {ρ}^{′} \\ [ \begin{matrix}cos ( \hat{α} ) \\ sin ( \hat{α} )\end{matrix} ] = {[ \begin{matrix}{C}_{11} & {C}_{21} \\ {C}_{12} & {C}_{22}\end{matrix} ]}^{- 1} \cdot [ \begin{matrix}cos ( {α}^{′} ) \\ sin ( {α}^{′} )\end{matrix} ] \\ \hat{α} = arctan ( sin ( \hat{α} ) , cos ( \hat{α} ) ) , \qquad ( 29 )$$

where arctan(sin(\hat{α}), cos(\hat{α})) is a 4-quadrant arctangent function. Determining line parameters in the horizontal frame by iteratively solving the non-linear equation system provided by equations (27) and (28) essentially rotates tilted scan image into a horizontal frame.

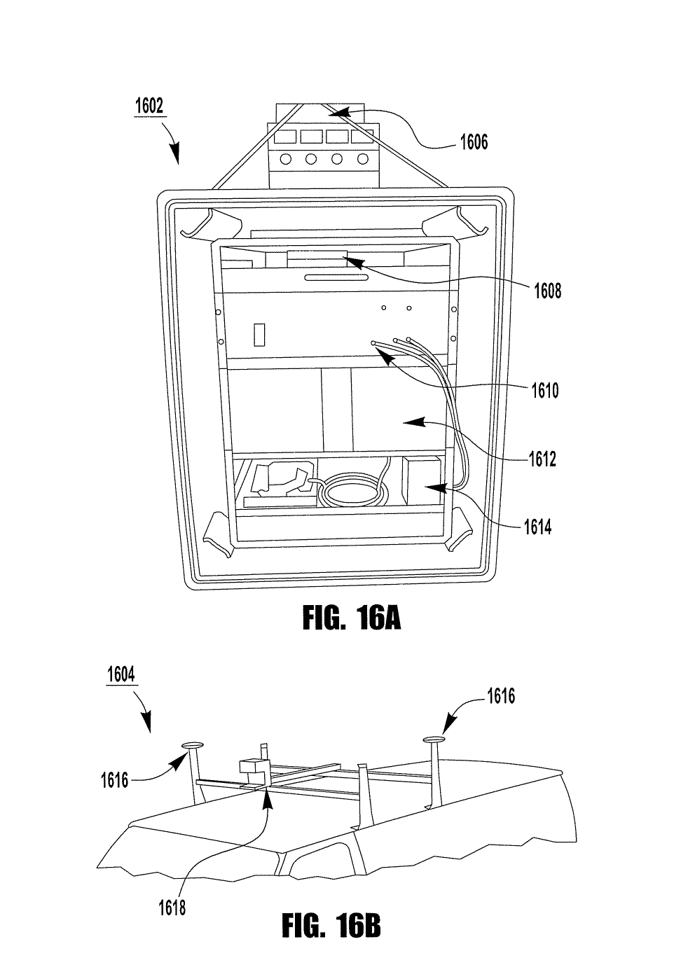

With reference to FIGS. 16A and 16B, an exemplary embodiment of an apparatus installed on a vehicle that enables the use of a multipath GPS signal may include an equipment rack 1602 (FIG. 16A) and roof-mounted equipment 1604 (FIG. 16B). The apparatus, for example, may be installed on a cargo van. The equipment rack 1602 may include one or more GPS receivers 1606, a laser controller 1608, a software-defined radio (SDR) with an RF component 1610 and a digital component 1612, and an IMU system 1614 with an IMU sensor and IMU circuitry. The roof-mounted equipment 1604 may include a GPS antenna arrangement 1616 and a laser sensor 1618.

The one or more GPS receivers 1606 may include an SiRF StarlI GPS receiver or one or two NovAtel OEM-4 GPS receivers, such as NovAtel model no. PowerPak-4E-L1L2W. SiRF Technology, Inc. may be contacted in San Jose, Calif. NovAtel, Inc. may be contacted in Calgary, Alberta, Canada. The GPS antenna arrangement 1616 may include one or two GPS antennas. In one embodiment, the GPS antenna arrangement 1616 may include a NovAtel pinwheel L1/L2 active antenna. The one or more GPS receivers 1606 may be used for sequential processing. The SDR 1610, 1612 and the IMU system 1614 may be used for batch processing. The laser sensor 1618 may be used for augmentation of the GPS.

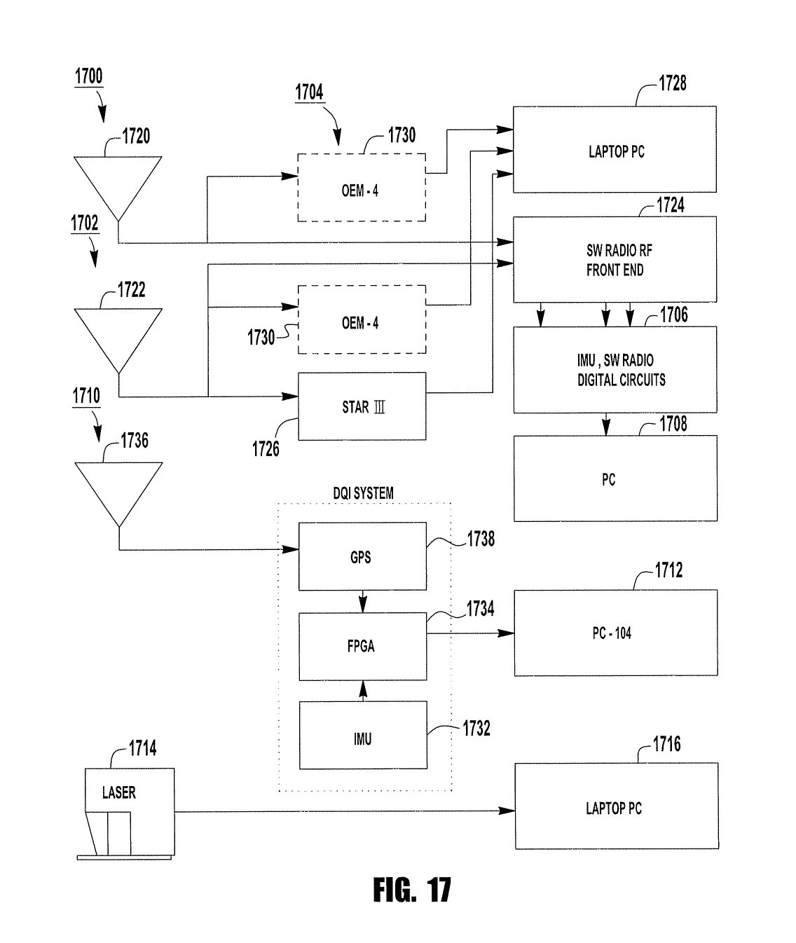

With reference to FIG. 17, an apparatus 1700 that enables the use of a multipath GPS signal may include a GPS antenna arrangement 1702, an RF front end 1704, digital circuits 1706, a personal computer (PC) 1708, an IMU system 1710, a controller 1712, a laser sensor 1714, and a laptop PC 1716. The PC 1708, controller 1712, and laptop PC 1716 may be in operative communication and may be configured to control the apparatus in any suitable integrated manner. In one embodiment, the PC 1708, controller 1712, and laptop PC 1716 may be combined in a central computer or controller. The GPS antenna arrangement 1702 may include one or two GPS antennas. In one embodiment, the CGPS antenna arrangement 1702 may include a first GPS antenna 1720 for the L1 frequency band with an internal amplifier and a second GPS antenna 1722 for the L1/L2 frequency bands with an external low-noise JCA amplifier. In another embodiment, the GPS antenna arrangement 1702 may include a NovAtel pinwheel L1/L2 active antenna.

The RF front end 1704 may include a software-defined radio (SDR) RF component 1724 in operative communication with the digital circuits 1706. In this embodiment, the digital circuits 1706 may include a corresponding SDR digital component.

The IMU system 1710 may include an IMU sensor 1732, a field-programmable gate array (FPGA) 1734, a GPS antenna 1736, and a GPS receiver 1738. The GPS receiver 1738 may be used to time stamp the IMU data. In one embodiment, the IMU system 1710, for example, may include a commercial digital quartz IMU (DQI) sensor available from Systron Donner Inertial of Walnut Creek, Calif. The laser sensor 1714, for example, may include a commercial laser measurement sensor, such as model no. LMS 200, available from Sick AG of Germany.

With reference to FIGS. 16A, 16B, and 17, an exemplary data acquisition system architecture may be installed in a Ford Econoline 350 cargo van with roof racks. One GPS channel may be used for deep integration processing. Two GPS channels, if available, may be used for redundancy. The SDR may employ a downconvert-and-digitize front-end. The GPS/IMU deep integration may be performed in post-processing. In one embodiment, the IMU system (1614, 1710) may include a tactical grade DQI sensor. The SiRF StarIII GPS receiver 1726 may be connected to a GPS antenna, such as the NovAtel pinwheel L1/L2 active antenna, via a signal splitter.

The laser sensor 1618, 1714 may provide continuously-panned distance measurements in a 180-degree arc in the horizontal plane. The data from the laser sensor 1618, 1714 may be recorded in increments of 0.25 degrees and may extend to distances of up to 80 meters with cm-level resolution. A Class 1 laser sensor may be used. Laser data, for example, may be synchronized to the IMU data and may be recorded on the laptop PC 1716.

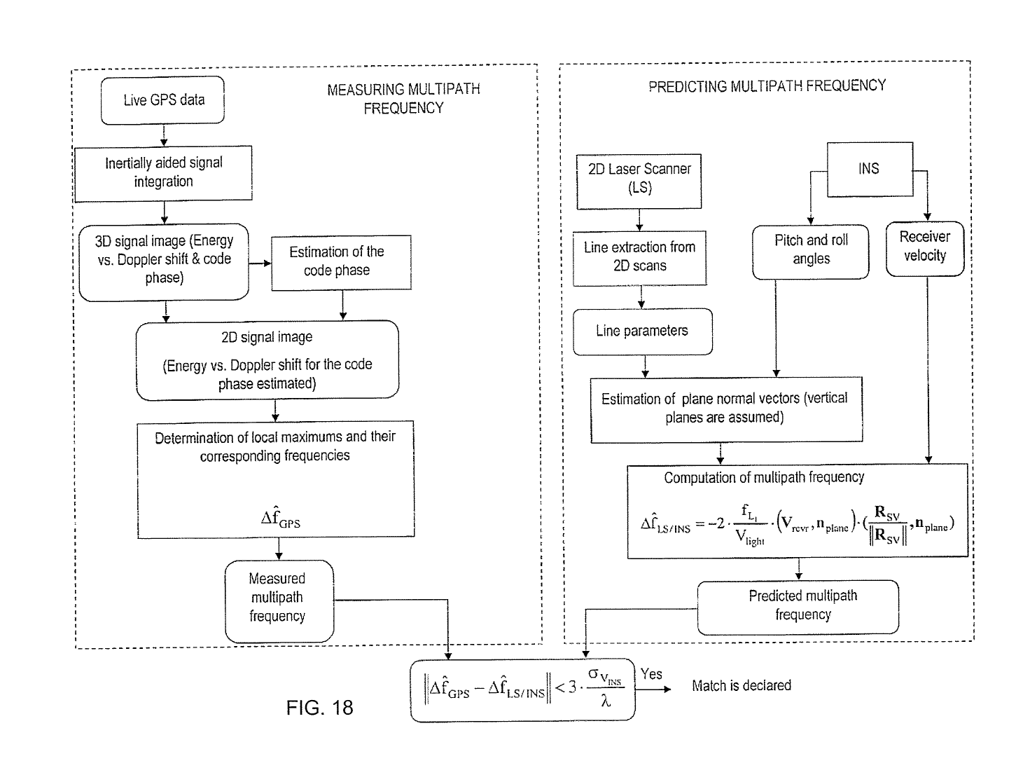

With reference to FIG. 18, an exemplary process is illustrated where predicted frequency differences are compared to signal frequencies measured from a plurality of received GPS signals. Measured frequencies can be extracted from a 3D GPS signal image via a local maxima search and a subsequent polynomial fit (see also FIG. 12). Predicted frequencies can be computed based on plane parameters extracted from measurements of a 2D laser scanner and a mobile object velocity estimate provided by an inertial navigator (see also FIG. 15). A predicted frequency value may be computed for every vertical plane extracted from a 2D laser scan image. Note that the zero frequency may be predicted for the direct signal for the case where inertial aiding is applied for the construction of the 3D GPS signal image. If the difference between the predicted and measured frequencies is below a certain threshold value, a match may be declared. A threshold value for matching of measured and predicted frequencies can be computed, for example, based on a standard deviation (std) value of inertial velocity error that is routinely estimated by the GPS/INS Kalman filter. For example, a three-sigma velocity std threshold can be applied for frequency matching.

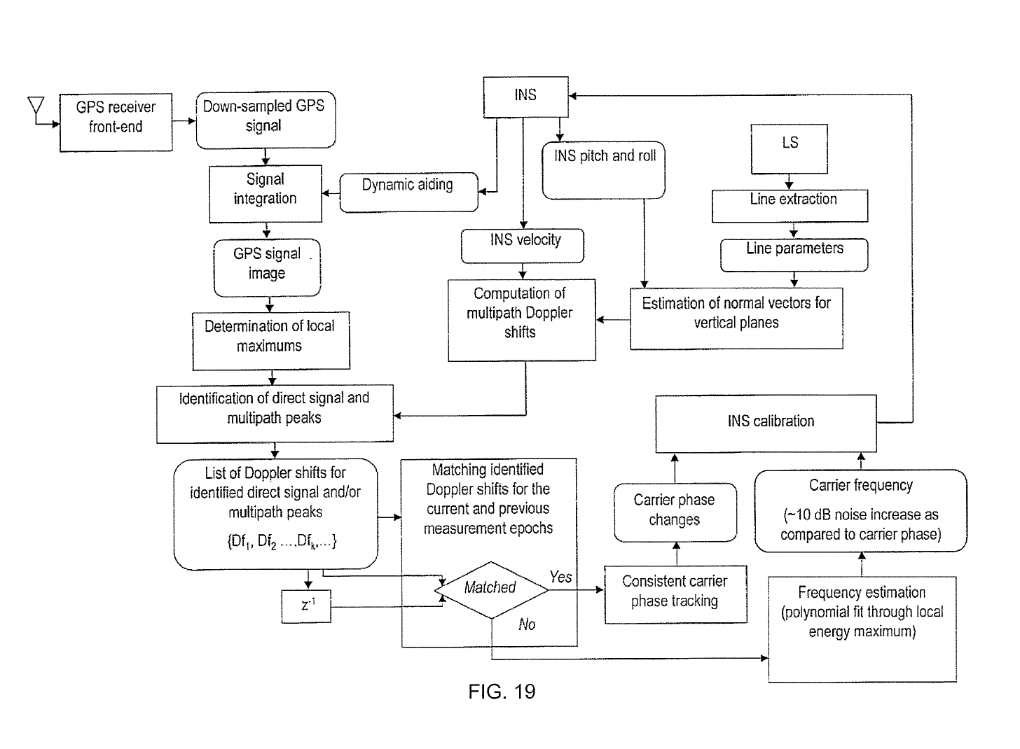

Multipath and direct satellite signals whose measured frequencies are matched to predicted frequencies can be used for navigation tasks. For example, these signals can be used to improve the accuracy of inertial aiding of the GPS signal accumulation via inertial calibration (INS calibration) as shown in FIG. 19. If a particular multipath (or direct) signal has been matched over at least two consecutive measurement epochs, its corresponding carrier phase measurements can be used for the inertial calibration via a GPS/INS Kalman filter. In this case, the Kalman filter measurement model may be derived from equation (5) and carrier phase changes over consecutive measurement epochs may be applied. For additional detail on how such carrier phase changes may be applied see U.S. Pat. App. Pub. No. 2006/0071851 to van Graas et al., the contents of which are fully incorporated herein by reference. If a multipath reflection of a direct signal is matched for the current epoch but was not matched for the previous epoch, the carrier frequency measurement can be used instead of the carrier phase measurement. In this case, the filter measurement model may be derived from equation (7). Note that a factor of 10 increase in the Kalman filter measurement noise may be introduced if the carrier frequency is used instead of carrier phase.

One consideration in comparing various embodiments of an apparatus and associated method using an integrated GPS/IMU architecture is the relationship between IMU cost and overall system performance. For example, to establish an empirical relationship between these two criteria, a simulation may be performed as follows. Three IMU sensor performance models may be created to span the performance space between the DQI (e.g., approximately $15,000) and IMUs expected to be available in the next few years (e.g., approximately $1,000). These models may be designated Low Grade IMU 1, 2 and 3. Inertial sensor data obtained from the DQI may be corrupted with accelerometer biases and gyroscope drifts. Inertial sensor errors may be simulated as first-order Gauss-Markov processes with a time constant of 100 seconds. The maximum deep GPS/IU integration period for each sensor performance model may be determined by identifying when the 3-sigma INS error, mapped into the position error space, exceeds one quarter wavelength of the GPS L1 carrier frequency. The resulting loss in CNR threshold may also be identified. The reduced integration times and CNRs for each sensor performance model may be applied to exemplary stationary cases and overall system performance may be determined in post-processing.

The 12 dB-Hz signal processing threshold may be used for the first IMU model and increased for each subsequent model (e.g., 13.4 dB-Hz and 15.3 dB-Hz). The number of SVs visible may be fairly insensitive to reductions in IMU quality. However, the most difficult stationary scenarios may show some reduction in SVs visible as a result of simulated IMU performance reductions. Unlike the number of SVs visible, the relationship between IMU cost and overall system performance may be more pronounced when comparing the number of SV channels displaying consistent carrier phase tracking for the different IMU sensor models. IMU performance levels better than 1 mg and 100 deg/hr (corresponding to a nominal cost of $4,000 per unit) may yield no improvement in overall system performance. IMU performance levels worse than 1 mg and 100 deg/hr may yield an almost linear reduction in overall system performance down to zero consistent carrier phase tracking channels in the most difficult scenario.

GPS signals in urban canyons may be characterized as they appear to a conventional GPS receiver; to an advanced receiver optimized for urban areas; and to a batch processing, deeply integrated GPS/IMU receiver with open-loop tracking architecture. Significant performance improvements may be noted for each successive architecture. Signals from 5 to 6 SVs may be available for processing by the deeply integrated GPS/IMU receiver even in very dense urban canyons. The quality of these signals for tracking purposes may be assessed in three respects. First, carrier phase-based integrated velocity may be shown to be accurate at least to cm level and to sub-mm level in some scenarios. Second, consistent carrier phase tracking may be demonstrated for at least 2 SVs in challenging scenario (e.g., where no direct path signals exists) and up to 5 SVs in less difficult scenarios. Third, signal tracking can break down when CNR is below 12 dB-Hz (corresponding to a 1 s integration interval) or due to multipath fading.

The difference in frequency between direct path and multipath GPS signals may provide a clear way to distinguish between these signals. Frequency is thus a potentially useful factor for identifying and tracking GPS signals in dynamic scenarios.

Finally, the relationship of cost versus performance for IMU quality in a deeply integrated GPS/IMU architecture may have a fairly smooth slope. The limiting performance factor may be the number of channels with consistent carrier phase tracking. For example, the range of interest in IMU unit estimated cost may range from less than $1,000 to $4,000. In the difficult scenarios (e.g., no direct path SV signals received), the improvement in overall system performance may increase nearly linearly with increased cost.

In summary, the various embodiments of methods and apparatus disclosed herein may be useful for localization in urban environments using GPS data collected in urban canyons. GPS signals, for example, collected on a Software Defined Radio (SDR) platform in urban canyons may be processed using a deeply integrated GPS/INS scheme. The deep integration scheme allows for coherent signal integration over time intervals as long as one (1) second (s). The deep integration mode may provide continuous carrier phase tracking. Performance results of the deep integration scheme show that signals from up to five (5) or six (6) SVs may be available for processing, even in dense urban canyons. Deep GPS/INS integration enables continuous carrier phase tracking and allows for cm/s level accurate velocity in urban environments. In contrast, velocity performance of current commercial low-sensitivity GPS receivers may yield errors at a one (1) m/s level. Additionally, continuous carrier phase tracking may be possible, even for cases where buildings block the satellite line of sight (LOS). Further, consistent carrier phase tracking may be performed for at least two (2) SVs where all LOS vectors are blocked by buildings and for up to six (6) SVs for other urban canyon scenarios. Tracking may remain consistent for weak signals with Carrier-to-Noise Ratios (CNRs), for example, as low as 12 dB-Hz.

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶ 6.

1. A method, including:
a) receiving a first GPS signal at a mobile object from a first satellite vehicle;
b) determining a distance characteristic relating a first reflecting object to the mobile object;
c) determining at least one inertial characteristic associated with the mobile object;
d) predicting at least one multipath signal characteristic associated with reflection of the first GPS signal by the first reflecting object toward the mobile object; and
e) determining the first GPS signal received in a) includes a first multipath signal associated with reflection of the first GPS signal by the first reflecting object toward the mobile object.

2. The method of claim 1, further including:
f) continuing to track the first satellite vehicle based at least in part on a carrier frequency component of the first multipath signal.

3. The method of claim 2, further including:
g) continuing to use at least one of carrier frequency, carrier phase, and GPS data from the first satellite vehicle based at least in part on at least one of a GPS carrier component and a GPS data component of the first multipath signal.

4. The method of claim 3 wherein at least one of the carrier frequency, carrier phase, and GPS data is used in conjunction with navigation of the mobile object through at least one of a benign urban environment, a moderate urban environment, and a difficult urban environment.

5. The method of claim 1 wherein the mobile object is moving during at least a), b), and c).

6. The method of claim 1 wherein the determining in b) is based at least in part on a first model of the first reflecting object represented in a previously-generated digital map of an operational environment in which the mobile object is located.

7. The method of claim 1 wherein the determining in b) is based at least in part on a first model of the first reflecting object represented by a plurality of reflecting surfaces in a previously-generated digital map.

8. The method of claim 1 wherein the determining in b) is based at least in part on a first measured parameter associated with a distance between the first reflecting object and the mobile object.

9. The method of claim 8 wherein the first measured parameter is measured by a distance measurement device and the measuring and determining in b) is performed in real-time.

10. The method of claim 1 wherein the predicting in d) is based at least in part on at least one of the distance characteristic determined in b) and at least one inertial characteristic determined in c).

11. The method of claim 1 wherein the determining in e) is based at least in part on at least one multipath signal characteristic predicted in d).

12. The method of claim 1, further including:
f) receiving a second GPS signal at the mobile object from a second satellite vehicle;
g) predicting at least one multipath signal characteristic associated with reflection of the second GPS signal by the first reflecting object toward the mobile object; and
h) determining the second GPS signal received in f) includes a second multipath signal associated with reflection of the second GPS signal by the first reflecting object toward the mobile object.

13. The method of claim 12, further including:
i) continuing to track the first and second satellite vehicles based at least in part on a first carrier frequency component of the first multipath signal and a second carrier frequency component of the second multipath signal.

14. The method of claim 13, further including:
j) continuing to use at least one of carrier frequency, carrier phase, and GPS data from the first and second satellite vehicles based at least in part on at least one of a first GPS carrier component and a first GPS data component of the first multipath signal and at least one of a second GPS carrier component and a second GPS data component of the second multipath signal.

15. The method of claim 14 wherein at least one of the carrier frequency, carrier phase, and GPS data is used in conjunction with navigation of the mobile object through at least one of a benign urban environment, a moderate urban environment, and a difficult urban environment.

16. The method of claim 1, further including:
f) receiving a second GPS signal at the mobile object from a second satellite vehicle;
g) determining a distance characteristic relating a second reflecting object to the mobile object;
h) predicting at least one multipath signal characteristic associated with reflection of the second GPS signal by the second reflecting object toward the mobile object; and
i) determining the second GPS signal received in f) includes a second multipath signal associated with reflection of the second GPS signal by the second reflecting object toward the mobile object.

17. The method of claim 16, further including:
j) continuing to track the first and second satellite vehicles based at least in part on a first carrier frequency component of the first multipath signal and a second carrier frequency component of the second multipath signal.

18. The method of claim 17, further including:
k) continuing to use at least one of carrier frequency, carrier phase, and GPS data from the first and second satellite vehicles based at least in part on at least one of a first GPS carrier component and a first GPS data component of the first multipath signal and at least one of a second GPS carrier component and a second GPS data component of the second multipath signal.

19. The method of claim 18 wherein at least one of the carrier frequency, carrier phase, and GPS data is used in conjunction with navigation of the mobile object through at least one of a benign urban environment, a moderate urban environment, and a difficult urban environment.

20. The method of claim 16 wherein the determining in g) is based at least in part on a second model of the second reflecting object represented in a previously-generated digital map of an operational environment in which the mobile object is located.

21. The method of claim 16 wherein the determining in g) is based at least in part on a second measured parameter associated with a distance between the second reflecting object and the mobile object.

22. An apparatus, including:
a GPS receiver adapted to receive a first GPS signal from a first satellite vehicle;
a storage device adapted to store at least a first parameter associated with a distance between a first reflecting object and the apparatus;
an inertial measurement device adapted to measure at least one parameter associated with movement of the apparatus; and
a controller in communication with the GPS receiver, distance measurement device, and inertial measurement device, the controller being adapted to i) determine a first distance characteristic relating the first reflecting object to the apparatus, ii) determine at least one inertial characteristic associated with the apparatus, iii) predict at least one multipath signal characteristic associated with reflection of the first GPS signal by the first reflecting object toward the apparatus, iv) determine the first GPS signal received by the GPS receiver includes a first multipath signal associated with reflection of the first GPS signal by the first reflecting object toward the apparatus, v) track the first satellite vehicle based at least in part on a first carrier frequency component of the first multipath signal, and vi) use at least one of carrier frequency, carrier phase, and GPS data from the first satellite vehicle based at least in part on at least one of a first GPS carrier component and a first GPS data component of the first multipath signal.

23. The apparatus of claim 22 wherein the controller is also adapted to use at least one of the carrier frequency, carrier phase, and GPS data in conjunction with navigation of the apparatus through at least one of a benign urban environment, a moderate urban environment, and a difficult urban environment.

24. The apparatus of claim 22 wherein the GPS receiver is also adapted to receive a second GPS signal from a second satellite vehicle;
wherein the controller is also adapted to i) predict at least one multipath signal characteristic associated with reflection of the second GPS signal by the first reflecting object toward the apparatus, ii) determine the second GPS signal received by the GPS receiver includes a second multipath signal associated with reflection of the second GPS signal by the first reflecting object toward the apparatus, iii) track the second satellite vehicle based at least in part on a second carrier frequency component of the second multipath signal, and iv) use at least one of carrier frequency, carrier phase, and GPS data from the second satellite vehicle based at least in part on at least one of a second GPS carrier component and a second GPS data component of the second multipath signal; and
wherein the controller is also adapted to use at least one of the carrier frequency, carrier phase, and GPS data in conjunction with navigation of the apparatus through at least one of a benign urban environment, a moderate urban environment, and a difficult urban environment.

25. The apparatus of claim 22 wherein the GPS receiver is also adapted to receive a second GPS signal from a second satellite vehicle;
wherein the storage device is also adapted to store at least a second parameter associated with a distance between a second reflecting object and the apparatus;
wherein the controller is also adapted to i) determine a second distance characteristic relating the second reflecting object to the apparatus, ii) predict at least one multipath signal characteristic associated with reflection of the second GPS signal by the second reflecting object toward the apparatus, iii) determine the second GPS signal received by the GPS receiver includes a second multipath signal associated with reflection of the second GPS signal by the second reflecting object toward the apparatus, iv) track the second satellite vehicle based at least in part on a second carrier frequency component of the second multipath signal, and v) use at least one of carrier frequency, carrier phase, and GPS data from the second satellite vehicle based at least in part on at least one of a second GPS carrier component and a second GPS data component of the second multipath signal; and
wherein the controller is also adapted to use at least one of the carrier frequency, carrier phase, and GPS data in conjunction with navigation of the apparatus through at least one of a benign urban environment, a moderate urban environment, and a difficult urban environment.

26. The apparatus of claim 22, further including:
a distance measurement device in communication with the storage device and adapted to measure the first parameter associated with the distance between the first reflecting object and the apparatus.

27. The apparatus of claim 26 wherein the distance measurement device includes a laser scanner.

28. The apparatus of claim 26 wherein measuring of the first parameter and determining the first distance characteristic are performed in real-time.

29. The apparatus of claim 26 wherein the storage device is also adapted to store a previously-generated digital map modeling an operational environment associated with the apparatus, the digital map including a first model representing the first reflecting object.

30. The apparatus of claim 29 wherein the GPS receiver is also adapted to receive a second GPS signal from a second satellite vehicle;
wherein the digital map associated with the storage device also includes a second model representing a second reflecting object;
wherein the controller is also adapted to i) determine a second distance characteristic relating the second reflecting object to the apparatus, ii) predict at least one multipath signal characteristic associated with reflection of the second GPS signal by the second reflecting object toward the apparatus, iii) determine the second GPS signal received by the GPS receiver includes a second multipath signal associated with reflection of the second GPS signal by the second reflecting object toward the apparatus, iv) track the second satellite vehicle based at least in part on a second carrier frequency component of the second multipath signal, and v) use at least one of carrier frequency, carrier phase, and GPS data from the second satellite vehicle based at least in part on at least one of a second GPS carrier component and a second GPS data component of the second multipath signal; and
wherein the controller is also adapted to use at least one of the carrier frequency, carrier phase, and GPS data in conjunction with navigation of the apparatus through at least one of a benign urban environment, a moderate urban environment, and a difficult urban environment.

31. A method of using signals from a plurality of radio navigation satellites while a receiver is mobile, comprising:
(a) receiving direct signals from a first set of the plurality of radio navigation satellites;
(b) providing direct satellite data corresponding to the direct signals received from the plurality of radio navigation satellites;
(c) receiving multipath signals from a second set of the plurality of radio navigation satellites;
(d) providing multipath satellite data corresponding to the multipath signals received from the plurality of radio navigation satellites;
(e) providing inertial data from an inertial measurement unit (IMU);
(f) providing position data for some structures in the vicinity of the receiver, which structures may have reflecting surfaces that provide some multipath reflections of direct signals from the plurality of radio navigation satellites; and
(g) using the direct satellite data, if any, and the multipath satellite data and the inertial data and the position data to perform continuous carrier phase tracking of the radio navigation satellite signals, including continuous carrier phase tracking of low CNR multipath signals, from the plurality of radio navigation satellites, while the receiver is moving through regions where structures prevent direct observation of some direct signals from the plurality of radio navigation satellites.

32. The method of claim 31 wherein (f) comprises using a distance measurement sensor to provide position data about reflecting surfaces in the vicinity of the receiver in real time, and wherein (g) comprises using the position data to determine whether a signal received from one of the plurality of radio navigation satellites is a direct signal or a multipath signal.

33. The method of claim 31 wherein (f) comprises providing stored, predetermined position data about reflecting surfaces in a region and accessing the stored, predetermined position data for some structures in the vicinity of the receiver within the region in real time, and wherein (g) comprises using the position data to determine whether a signal received from one of the plurality of radio navigation satellites is a direct signal or a multipath signal.

34. The method of claim 31 wherein (g) comprises using multipath satellite data for some radio navigation satellites having signals not being directly received by the receiver and using direct satellite data for some radio navigation satellites having signals being directly received, if any.

35. The method of claim 34 wherein (g) further comprises using both multipath satellite data and direct satellite data for radio navigation satellites having both direct signals and multipath signals being received by the receiver.

36. A receiver for using signals, including low carrier-to-noise ratio (“CNR”) multipath signals, from a plurality of radio navigation satellites while the receiver is mobile, comprising:
(a) a radio frequency (RF) front-end that provides satellite data corresponding to signals received directly from some of the plurality of radio navigation satellites and that provides multipath data corresponding to multipath signals received from some of the plurality of radio navigation satellites; and
(b) an inertial measurement unit (EMU) that provides inertial data;
(c) position data for some structures in the vicinity of the receiver, which structures may have reflecting surfaces that provide some multipath reflections of the low CNR signals from the plurality of radio navigation satellites; and
(d) a processor circuit in circuit communication with the RF front end and the IMU, the processor circuit being capable of using the satellite data and the multipath data and the inertial data and the position data to perform continuous carrier phase tracking of radio navigation satellite signals, including low CNR multipath signals, from the plurality of radio navigation satellites while the receiver is moving through regions where structures prevent direct observation of some signals from the plurality of radio navigation satellites.

37. The receiver of claim 36 further comprising a distance measurement sensor to provide position data about reflecting surfaces in the vicinity of the receiver in real time, and wherein the position data is used to determine whether a signal received from one of the plurality of radio navigation satellites is a direct signal or a multipath signal.

38. The receiver of claim 36 further comprising a storage unit for storing predetermined position data about reflecting surfaces in a region and wherein the processor circuit accesses predetermined position data for some structures in the vicinity of the receiver within the region in real time, and wherein the position data is used to determine whether a signal received from one of the plurality of radio navigation satellites is a direct signal or a multipath signal.

39. The receiver of claim 36 wherein the processor circuit uses multipath data for some radio navigation satellites having signals not being directly received by the receiver and uses satellite data for some radio navigation satellites having signals being directly received, if any.

40. The receiver of claim 39 wherein the processor circuit uses both multipath satellite data and direct satellite data for radio navigation satellites having both direct signals and multipath signals being received by the receiver.
